(19) United States
(12) Patent Application Publication
(10) Pub. No.: US 2023/0031767 A1
(43) Pub. Date: Feb. 2, 2023

(54) ZAAF - Augmented Analytics Framework with Deep Metrics Discovery

(71) Applicant: Zoho Corporation Private Limited, Chengalpaltu Taluk (IN)

(72) Inventors: Saswata Bhattacharya, Kolkata (IN); Liju Anton Joseph Antony Britto, Tamil Nadu (IN); Bangaru Siva Kumar Narkidimilli, Andhra Pradesh (IN); Jayanthi Thangaraj, Tamil Nadu (IN); Sravani Yerramada, Telangana (IN); Shanmuga Sundaram Srinivasan, Tirunelveli (IN)

(21) Appl. No.: 17/867,310

(22) Filed: Jul. 18, 2022

Related U.S. Application Data
(60) Provisional application No. 63/257,190, filed on Oct. 19, 2021.

(30) Foreign Application Priority Data
Jul. 16, 2021 (IN) 202141032082
Jul. 16, 2022 (IN) 202141032082

(51) Int. Cl. G06Q 10/06

(52) U.S. Cl. CPC G06Q 10/06375; G06Q 10/067

(57) ABSTRACT

Zia Augmented Analytics Framework (ZAAF) will find insights based on metrics based Augmented analytics. ZAAF will find the supporting metrics by taking all possible combination of aggregates of continuous columns with conditions on categorical columns and grouped by with period columns. Then using statistical analysis, it will filter out the important supporting metrics that affects the target metrics. Then using machine learning techniques, it will perform descriptive, predictive, prescriptive analysis on that supporting metrics with respect to target metrics.

### CROSS-REFERENCE TO RELATED APPLICATIONS

The present application claims priority to U.S. Provisional Patent Application No. 63/257,190 filed Oct. 19, 2021, Indian Provisional Patent Application No. 202141032082 filed Jul. 16, 2021, and Indian Non-Provisional Patent Application No. 21659/2022 filed Jul. 16, 2022, all of which are hereby incorporated by reference herein.

### BACKGROUND

Business intelligence (BI) comprises the strategies and technologies used by enterprises for the data analysis of business information. BI technologies provide historical, current, and predictive views of business operations. Common functions of business intelligence technologies include reporting, online analytical processing, analytics, dashboard development, data mining, process mining, complex event processing, business performance management, benchmarking, text mining, predictive analytics, and prescriptive analytics. BI technologies can handle large amounts of structured and sometimes unstructured data to help identify, develop, and otherwise create new strategic business opportunities. They aim to allow for the easy interpretation of these big data. Identifying new opportunities and implementing an effective strategy based on insights can provide businesses with a competitive market advantage and long-term stability. Augmented analytics, an approach of data analytics that employs the use of machine learning and natural language processing to automate analysis processes, is based on business intelligence and analytics.

### SUMMARY

In this cloud era, every business is generating a large volume of data. As the size of the data grows, the complexity of taking decisions based on the historical data is also increased. By doing this, at certain point it will be impossible to analyze large volume of data. So, our augmented analytics framework will solve this problem by automatically finding the insights from that large volume of data and it will help the business users to take decisions. All augmented analytics frameworks available in the current market are based on field level analysis.

Zia Augmented Analytics Framework (ZAAF) will find insights based on metrics based augmented analytics with the help of machine learning; it can analyze historical data and figure out the important supporting metrics that have impact on the given target metrics. With the help of machine learning, this framework can answer questions like:

1) What could happen?

2) What went wrong?

3) Why had it happened?

4) What should I do?

5) What happened today?

### BRIEF DESCRIPTION OF THE DRAWINGS

FIG. 1 is a block diagram of an example of an augmented analytics framework.

FIG. 2 is a diagram of an example of stored data.

FIG. 3 depicts an example of metrics representation.

FIG. 4 depicts an example of a user interface (UI) for specifying target metrics.

FIG. 5 depicts an example of extracted components from target metrics.

FIG. 6 depicts an example of all metric representation.

FIG. 7 depicts an example of most important supporting metrics representation.

FIG. 8 depicts an example of a UI for default strategy for a next period.

FIG. 9 depicts an example of a UI for changing supporting metrics value.

FIG. 10 depicts an example of a UI for target predictions for custom strategy.

FIG. 11 depicts an example of a UI for changing target metrics value.

FIG. 12 depicts an example of a UI for strategy suggestions for achieving a target.

FIG. 13 depicts an example of a UI for a flaw finder.

FIG. 14 depicts an example of a UI for a predictor.

FIG. 15 depicts an example of a training block diagram.

FIG. 16 depicts an example of extracted components from target metrics.

FIG. 17 depicts an example of a block diagram for deep metrics discovery.

FIG. 18 depicts an example of a representation for a transformation table.

FIG. 19 depicts an example of a binning transformation.

FIG. 20 depicts an example of many-to-one relationship schema.

FIG. 21 depicts an example of a joined many-to-one relationship table.

FIG. 22 depicts an example of a one-to-many relationship schema.

FIG. 23 depicts an example of joined one-to-many relationship table.

FIG. 24 depicts an example of all metric representation.

FIG. 25 depicts an example of categorical columns and a target metric column.

FIG. 26 depicts an example of output of analysis of variance (ANOVA).

FIG. 27 depicts an example of a target metrics value for each column value in a city column.

FIG. 28 depicts an example of a target metrics value for each column value in a sales rep name column.

FIG. 29 depicts an example of a block diagram for Target Metrics-Supporting Metrics (TMSM) association modeling.

FIG. 30 depicts an example of an important supporting metrics representation.

FIG. 31 depicts an example of a combined flow diagram for a strategy planner.

FIG. 32 is a diagram an example of an anomaly analyzer flow.

FIG. 33 depicts an example of a block diagram for a predictor.

FIG. 34 depicts an example of historical data for target metrics.

FIG. 35 depicts an example of output of a univariate timeseries predictor.

FIG. 36 depicts an example of a UI for setting short-term goals to achieve a long term expected target.

FIG. 37 depicts an example of a UI for suggestions to achieve an expected target.

FIG. 38 depicts an example of a UI for reasons for flaw in past days.

FIG. 39 depicts an example of a UI for boosting an expected value to compensate for loss incurred on previous days.

FIG. 40 depicts an example of a UI for comparing expected mode and boosting mode.

FIG. 41 is a flowchart of an example of a timeseries pattern analyzer.

### DETAILED DESCRIPTION

ZAAF (Zia Augmented Analytics Framework) is an augmented analytics framework supporting descriptive analytics (Flaw Finder), predictive analytics (Predictor), prescriptive analytics (Prescriptor), and strategy planning (Strategy Planner) based on deep metrics discovery on relational data with machine learning. Aspects of the ZAAF are described below with reference to the various figures.

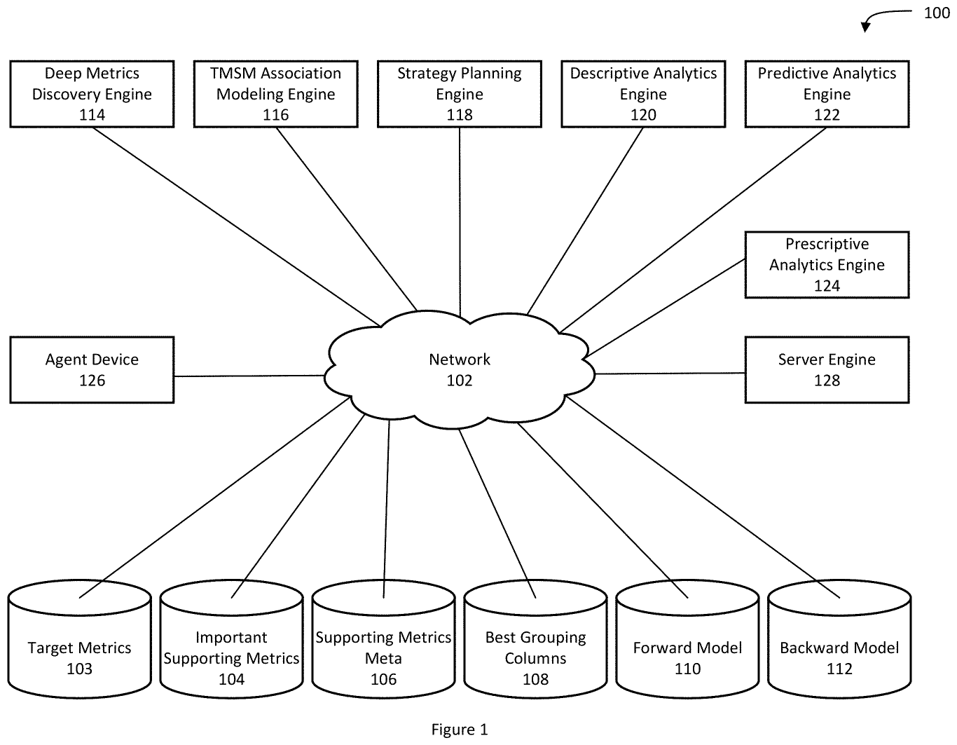

FIG. 1 is a diagram 100 of an example of an augmented analytics framework. The diagram 100 includes a network 102, a target metrics datastore 103 coupled to the network 102, an important supporting metrics datastore 104 coupled to the network 102, a supporting metrics meta datastore 106 coupled to the network 102, a best grouping columns datastore 108 coupled to the network 102, a forward model datastore 110 coupled to the network 102, a backward model datastore 112 coupled to the network 102, a deep metrics discovery engine 114 coupled to the network 102, a Target Metrics-Supporting Metrics (TMSM) association modeling engine 116 coupled to the network 102, a strategy planning engine 118 coupled to the network 102, a descriptive analytics engine 120 coupled to the network 102, a predictive analytics engine 122 coupled to the network 102, a prescriptive analytics engine 124 coupled to the network 102, an agent device 126 coupled to the network 102, and a server engine 128 coupled to the network 102.

The network 102 and other networks discussed in this paper are intended to include all communication paths that are statutory (e.g., in the United States, under 35 U.S.C. 101), and to specifically exclude all communication paths that are non-statutory in nature to the extent that the exclusion is necessary for a claim that includes the communication path to be valid. Known statutory communication paths include hardware (e.g., registers, random access memory (RAM), non-volatile (NV) storage, to name a few), but may or may not be limited to hardware.

The network 102 and other communication paths discussed in this paper are intended to represent a variety of potentially applicable technologies. For example, the network 102 can be used to form a network or part of a network. Where two components are co-located on a device, the network 102 can include a bus or other data conduit or plane. Where a first component is co-located on one device and a second component is located on a different device, the network 102 can include a wireless or wired back-end network or LAN. The network 102 can also encompass a relevant portion of a WAN or other network, if applicable.

The devices, systems, and communication paths described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g., “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

Returning to the example of FIG. 1, the target metrics datastore 103 is intended to represent a datastore of target metrics. A metric is a quantifiable measure that is used to track and assess the status of a specific process. Target metrics are metrics that define the success of an aspect of a process that is being analyzed. Target metrics can be acquired, for example, from the agent device 126, on which a human or artificial agent provides components of target metrics, from which target metrics are extracted from a larger datastore. As used in this example, the target metrics datastore 103 is a subset of a larger datastore that, at least conceptually, includes only data that can be characterized as supporting metrics for selected target metrics, as will become clearer later with description of the engines. Also, for the purposes of this example, the server engine 128 is assumed to have access to the larger datastore.

The target metrics datastore 103 can include a variety of tables, which include an agents (e.g., user) table, a task (e.g., deals) table, and an interaction (e.g., email or calls) table. Inherent in a system that includes interaction outside of an organization is a third party (e.g., customer, client, beneficiary, benefactor, or other party) datastore, which may or may not be referred to as a table. In an implementation that includes resource utilization, a datastore of resources would also be used. The roles and other characteristics of agents can be referred to as criteria on which analytics can be performed. Roles need not be formal titles; for example, an agent could have a role as “participant” if utilization of a conference room is analyzed.

The agents table can include human or artificial agents. For example, if analysis of resources is desired, an artificial agent can represent a resource monitor. Artificial agents can be distinguished within a single computer system. For example, a program that monitors advertising effectiveness on a website could comprise multiple agents for different locations, specific ads, or the like, just as a single human could be an agent in different capacities. Agents can also be grouped, for example, to determine team effectiveness for various compositions of employees. Interaction can include interactions outside an organization, with third parties, interactions within an organization, between employees, interactions with resources, or some other applicable interaction for which analysis is desired.

Target and supporting metrics vary by context. For example, in an example involving care for patients suffering from Covid, the “Deals Table” could be replaced with a patient table. A patients table could include rows of patients with columns for patient id, hospital id, physician id, country, detection date, speed of recovery, treatments, or the like. A hospital table could include rows of hospitals with columns for hospital id, whether the hospital is government or private, specific resources (e.g., respirators on hand or beds available). A doctors table might include doctor id, years of practice, number of patients, or the like. Foreign keys can connect the various tables. In this context, supporting metrics can be gathered for target metrics querying how to reduce the number of deaths in government hospitals, with suggestions including, for example, increasing the number of respirators on hand to a certain value, increasing capacity within a given ward, etc.

In a human resources (HR) context, the “Deals Table” could be replaced with a candidate table with rows representing candidates for a job and columns that include, for example, candidate id, city (connected via a foreign key to a city table), manager id (connected via foreign key to an employee or interviewer table), age, rating, whether hired, team id (connected via foreign key to a team table), position sought by candidate, credentials of candidate, or the like. A rounds table could include rows representing rounds spent interviewing candidates and columns that include round id, date, duration, location, and question id; and a question table could include rows representing interview questions and columns that include question id and difficulty level. In this context, target metrics can be to increase the number of selected candidates. Supporting metrics might be to increase candidates from a particular school, increase average number of rounds, increase HR manager years of experience, and increase candidates from a particular state or city.

A database management system (DBMS) can be used to manage a datastore. In such a case, the DBMS may be thought of as part of the datastore, as part of a server, and/or as a separate system. A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example of FIG. 1, the important supporting metrics datastore 104 is intended to represent a datastore of contributing factors for target metrics. Supporting metrics are metrics that impact target metrics; adjusting supporting metrics values changes target metrics values. (In this paper, contributing factors are typically referred to as supporting metrics, but can also be referred to as supporting factors.) “Importance,” as used in this paper, can be characterized as a degree of correlation between target metrics and supporting metrics over time. The “most important” metrics can be characterized as those metrics that exceed a degree-of-correlation threshold.

The supporting metrics meta datastore 106 is intended to represent a datastore of meta information. Meta information is generated by the deep metrics discovery engine 114 and can be used by the other engines, all of which are described in more detail below. In a specific implementation, supporting metrics meta is used to display information on the agent device 126, for example, in a user interface (UI) in an understandable way.

The best grouping columns datastore 108 is intended to represent a datastore of important categorical columns. As used here, “best” means “most important.” The deep metrics discovery engine 114 selects the important categorical/grouping columns are from a target metrics table, which may be referred to as a “primary table” in this paper, along with the most important values for them, and stores them in the best grouping columns datastore 108 and can be used by the other engines, all of which are described in more detail below. In a specific implementation, an analysis of variance (ANOVA) test is used to find important categorical/grouping columns, which are selected based on an F-score, a measure of the test's accuracy, with the categorical columns having a higher F-score considered ahead in the order of importance.

The forward model datastore 110 includes a forward model generated by the deep metrics discovery engine 114. The deep metrics discovery engine 114 determines a relation between the supporting metrics and target such that it can predict the target metrics given the values of the supporting metrics. In a specific implementation, this is achieved with the help of a constrained linear regression model fit with the historical data, where the supporting metrics are input variables and target metrics are the output variables. The forward model can be used by the predictive analytics engine 122 to predict a value of target metrics given the values of supporting metrics.

The backward model datastore 112 includes a backward model generated by the deep metrics discovery engine 114. The deep metrics discovery engine determines a relation between the supporting metrics and target such that it can predict the values of the supporting metrics given the value of the target metrics. The backward model can be used by the predictive analytics engine 122, combining target metrics values with the backward model, to predict to return corresponding supporting metrics values.

The deep metrics discovery engine 114 is intended to represent an engine responsible for discovering at least some supporting metrics (e.g., the most important supporting metrics) by analyzing data and metadata with respect to the target metrics. In a specific implementation, the deep metrics discovery engine 114 takes target metrics from the target metrics datastore 103, data, and metadata and schema as input. Data can be acquired from the server engine 128, which is assumed to include data on which analytics is to be run. Metadata and schema can also be acquired from the server engine 128 and can include foreign key connections between tables, primary key column information, data types of each column of the tables (e.g., numerical, categorical, date, time, index), display names for each column, units for numerical columns, and format and time zone information for date and time columns. In a specific implementation, the deep metrics discovery engine 114 stores, as output, important supporting metrics in the important supporting metrics datastore 104, supporting metrics meta information in the supporting metrics meta datastore 106, and important categorical/grouping columns of the target metrics in the best grouping columns datastore 108.

A computer system can be implemented as an engine, as part of an engine or through multiple engines. As used in this paper, an engine includes one or more processors or a portion thereof. A portion of one or more processors can include some portion of hardware less than all the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor that is a component of the engine. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

Referring once again to the example of FIG. 1, the TMSM association modeling engine 116 is intended to represent an engine responsible for determining a relationship between target and supporting metrics. In a specific implementation, the TMSM association modeling engine 116 takes as input historical data for supporting metrics and target metrics and supporting metrics meta information. Historical data for metrics means the value of metrics over timelines of past periods, which is used for both supporting and target metrics. The TMSM association modeling engine 116 may also use a correlation coefficient and range information of the supporting metrics from the supporting metrics meta information datastore 106.

In a specific implementation, the TMSM association modeling engine 116 determines a relation between the supporting metrics and target such that it can predict the target metrics given the values of the supporting metrics. This can be achieved, for example, with the help of a constrained linear regression model fit with the historical data, where the supporting metrics are input variables and target metrics are the output variables. Regression basically finds an optimum equation which best maps the input variables to the target. The output of this process is the forward model, which is stored in the forward model datastore 110.

In a specific implementation, the TMSM association modeling engine 116 determines a relation between the supporting metrics and target such that it can predict the values of the supporting metrics given the value of the target metrics. This can be achieved, for example, by fitting several linear regression models on data, where each model takes the target metrics as input and predicts a supporting metric; if there are n number of supporting metrics, there will be n number of regression models, which are named. In this specific implementation, the named regression models, which map the target metrics to supporting metrics, comprise the backward model that is stored as output in the backward model datastore 112.

The strategy planning engine 118 is intended to represent an engine that provides strategies, such as a default strategy, target prediction for custom strategy, or strategy suggestion to achieve a target. Inputs for a default strategy include period; inputs for a target prediction for custom strategy include period and an agent-specified target metrics value; and inputs for a strategy suggestion to achieve a target include period and an agent-specified supporting metrics value. In a specific implementation, the strategy planning engine 118 incorporates a timeseries predictor, accepting as input historical data, e.g., a timeseries, prediction start timestamp, and end timestamp. Timeseries data can be characterized as a list of timestamp and values where the timestamps are in chronological order, and the consecutive timestamps are equispaced (the time difference between the timestamps should be equal). The timeseries predictor can be implemented as a univariate timeseries predictor that uses timeseries decomposition technique, Auto-Correlation Function (ACF), and moving average to predict a value for future timestamps that fall between the start and end timestamps provided as an input.

Using a forward model from the forward model datastore 110, the strategy planning engine 118 can predict the value of target metrics given the values of supporting metrics. In a specific implementation in which the forward model was trained on standardized values, the supporting metrics values are scaled using a standardization technique. Feature values are passed to the forward model to predict the value of the target metrics. The predicted target metrics are then provided to the agent device 126 through an applicable interface.

Using a backward model from the backward model datastore 112, the strategy planning engine 118 can predict the value of supporting metrics given the value of target metrics. In a specific implementation in which the backward model contains ‘n’ linear regression models for ‘n’ supporting metrics, the strategy planning engine 118 feeds target metrics values to each component model to obtain a corresponding supporting metrics value. The predicted supporting metrics values are provided to the agent device 126 through an applicable interface.

In a specific implementation, the forward model predicts the target metrics from the supporting metrics using constraint regression model and the backward model predicts the supporting metrics value from the target metrics using separate regression models. A problem is after calculating the supporting metrics value from the backward model, if we fed those supporting metrics values to the forward model, the returned predicted target metric value may not be equal to the actual target metric value (which we fed as input to the backward model). Therefore, this error should be eliminated by adjusting the supporting metrics value to make the forward and the backward model in sync. This can be achieved using a TMSM sync engine that adjusts a supporting metrics value to put the forward and the backward model in sync.

In default strategy mode, the strategy planning engine 118 shows a likely strategy an agent is going to follow in a given period, including the value of target metrics that could be achieved with that strategy. In target prediction for custom strategy mode, the strategy planning engine 118 obtains supporting metrics values from the agent and shows how those supporting metrics values effect the target metrics. In strategy suggestion to achieve a target mode, the strategy planning engine 118 obtains target metrics values from the agent and shows how those target metrics can be achieved with values of the supporting metrics, assuming they can be achieved.

The descriptive analytics engine 120 is intended to represent an engine that detects if any anomaly has happened in the target metric for a specified time period in the past. In a specific implementation, if an anomaly happens, an anomaly reason finder engine will find the major contributing reasons for that anomaly with its impact on the target metric, including top reasons for the anomaly by ranking the reasons. Inputs to the descriptive analytics engine 120 include analysis time period, historical data for target and supporting metrics, and anomaly scan direction. The analysis time period is a time period in the past for which we need to check if anomaly has happened. Historical data for the target and supporting metrics contains the values for all these metrics in the past, which can be used to analyze trends and anomalies.

Anomaly scan direction, which can be positive or negative, tells the descriptive analytics engine 120 the direction in which it should search for anomaly. When anomaly scan direction is positive, the descriptive analytics engine 120 should only flag anomalies that happened in the positive direction (i.e., when the value of the target metrics is greater than the expected value). For example, let us say that the target metrics is the number of covid cases in a state; the desired anomaly scan direction should be positive because fewer cases than expected is desirable. Similarly, the desired anomaly scan direction for target metrics that measure company revenue should be negative because greater revenue than expected is desirable. Anomaly scan direction can also be “both,” which means anomaly should be scanned in both directions.

The output of the descriptive analytics engine 120 is a target metrics anomaly score and anomaly reasoning.

The predictive analytics engine 122 is intended to represent an engine responsible for predicting a target metrics value for a future period. Inputs to the predictive analytics engine 122 include historical data of the target metrics, represented in the target metrics datastore 103, for each category of the most important categorical column, represented in the best groupings columns datastore 108. Historical data can be obtained from the server engine 128. In a specific implementation, the predictive analytics engine 122 shows the breakup of its prediction with respect to the most important categorical column. To do that, each of the timeseries (target metrics timeseries and timeseries of the target metrics for each group) of the historical data is fed into a timeseries predictor engine, which makes predictions for each of those timeseries for a period in the future.

In a specific implementation, the timeseries predictor engine includes a univariate timeseries predictor. The input to the univariate timeseries predictor is historical data (timeseries), the prediction start timestamp, and end timestamp. The univariate timeseries predictor predicts the value for the future timestamps which falls between the start and end timestamps provided as an input to the engine. The engine may use timeseries decomposition technique, ACF, and moving average to make the prediction.

The prescriptive analytics engine 124 is intended to represent an engine that guides an agent to achieve expected goals by providing suggestions or rules to be followed. Inputs to the predictive analytics engine 122 include historical data of the target metrics, represented in the target metrics datastore 103. In a specific implementation, the prescriptive analytics engine 124 sets short-term goals to achieve long-term targets in the form of a strategy and if an expected target is not achieved, the prescriptive analytics engine 124 can be used to find the major contributing reasons for the discrepancy between actual and expected value.

The agent device 126 is intended to represent a computer used by an agent. In a specific implementation, the agent is human and the agent device 126 is an end-user (or edge) device, such as a smartphone, laptop, desktop, or other computing device.

The server engine 128 is intended to represent an engine that acts as a server for the agent device 126 and the other engines. It can be split into multiple different server engines, which is not unlikely in real-world implementations given the server engine 128 acts as a data server for the engines and, e.g., a web server for the agent device 126, as used in this example.

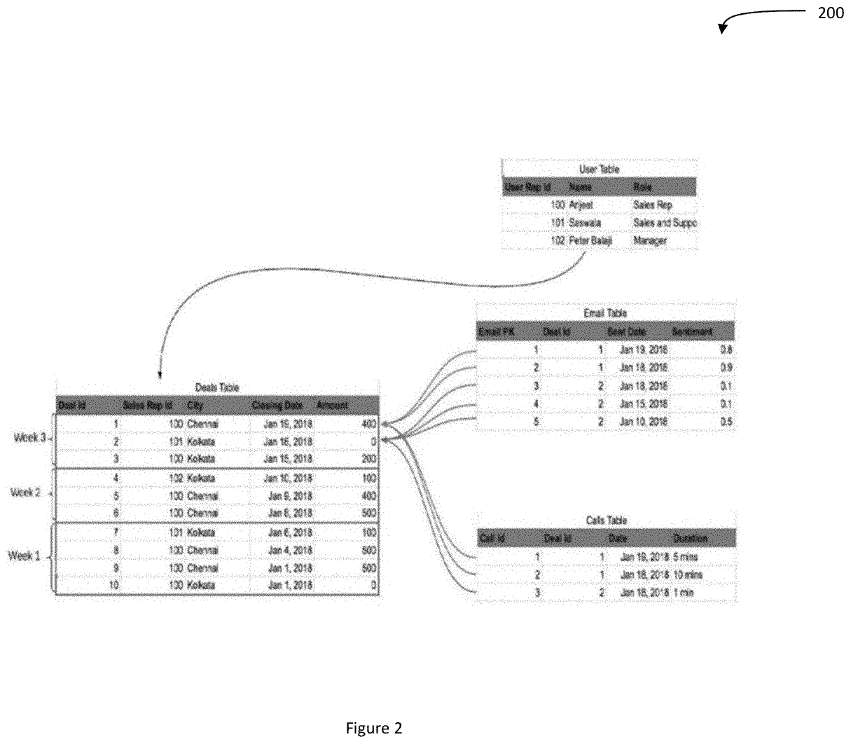

FIG. 2 depicts an example of a stored data diagram 200. The diagram 200 includes a User Table, Deals Table, Email Table, and Calls Table. The following paragraphs make use of a case study of a sales process of a company named as Zykler Pvt Ltd., a fictional entity, for illustrative purposes. In a study data scenario, Zykler Pvt Ltd sells computer hardware to the IT companies all over India. They have sales representatives who approach different IT companies in India and try to sell their computers. They communicate with their clients (IT companies) via calls and emails. They track all the sales and communication information in their relational database.

Sales representatives of Zykler are included in the User table. (Here “user” means the employees of Zykler.) User table includes User Rep Id (a unique identifier of a sales representative), Name (a sales representative's name), and Role (a designation of the sales representative).

Deals are included in the Deals table. In this example, the sales representative of the company every day sells IT hardware to different IT companies in India. The sales information is stored in the Deals table. Each record of this table represents a Deal, which is information about a particular sale that is being made by a Sales representative of Zykler to a customer (IT company). The Deals table includes Deal Id (a unique identifier of a deal for which email has been sent; these are organized in a foreign key column which refers to the Deal Id of the Deals table), Sales Rep Id (the sales representative who made the sale), City (the city of a customer), Closing Date (the date on which the customer pays Zykler for the IT hardware that was being sold), and Amount (amount the customer paid for the hardware purchase).

For a particular deal, a lot of emails are presumably exchanged between the Zykler sales representative and the customer. The Email table includes information related to the emails, such as Email PK, Deal Id, Sent Date, and Sentiment (Sentiment is a number between 0 to 1 which tells us about the sentiment of the email where 1 means customer is very happy and 0 means customer is very unhappy.

For a particular deal, a lot of calls are presumably made between the Zykler sales representative and the customer. The Calls table includes information related to the calls, such as Call Id, Deal Id (a unique identifier for the deal for which the call has been made; these are organized in a foreign key column which refers to the Deal Id of the Deals table), Date, and Duration.

A need for analytics represented here as 7 questions from Zykler management: 1) What is my predicted revenue for this week and how can I achieve it? 2) How much revenue Zykler can achieve if average sentiment of the Emails is improved to 0.8? 3) What should be my strategy for achieving $80,000 of revenue? 4) What went wrong last month? 5) Why was my last month's revenue less by $10,000? 6) What is Zykler's predicted revenue? 7) What strategy should I follow to have better revenue? Before getting into the technique how ZAAF answers these 7 questions, it is useful to define what is a metrics as an underlying concept for this framework is discovering the important metrics.

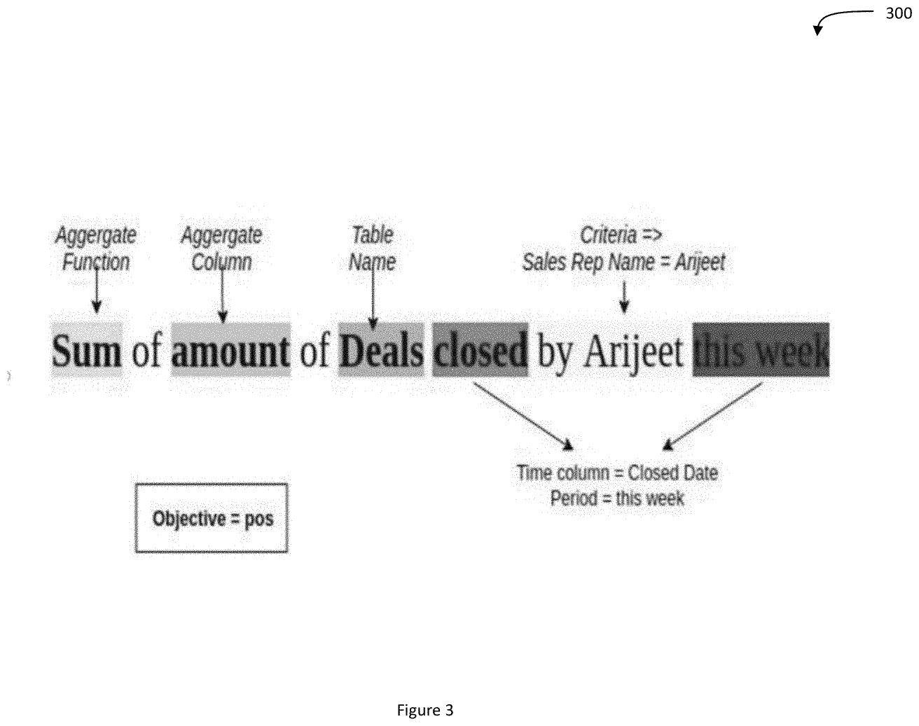

In developer's language, metrics can be characterized as a select query that has aggregates on a column based on a specific time index. The components of a select query appropriate for this example includes a Table (the name of the table on which the metrics is based (e.g., Deals table)), Aggregate Function (the aggregate function used on column; examples of aggregate functions sum, count, max, min, etc.), Aggregated Column (the column on which the aggregate function is applied; in this example, it is a mostly numerical column), Time Column (metrics are measured against a time column for a particular period, such as the Number of Deals closed this week, which means the deals that have a closing time this week where closing time is Time Column and period is week), Criteria (for example, if you only want the Deals from India, that might be a criteria), and Objective (when the value of this component is positive it means that if this metric increases, it is good for the user, and if this metric decreases, it is bad for the user; vice versa when the component is negative). An example of a metric representation appropriate for this example is illustrated in FIG. 3.

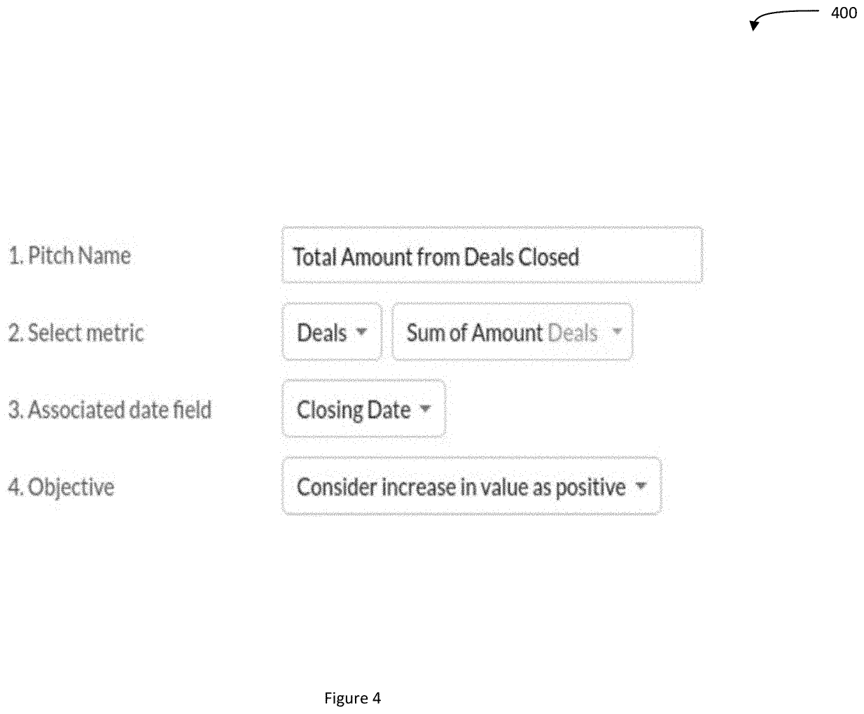

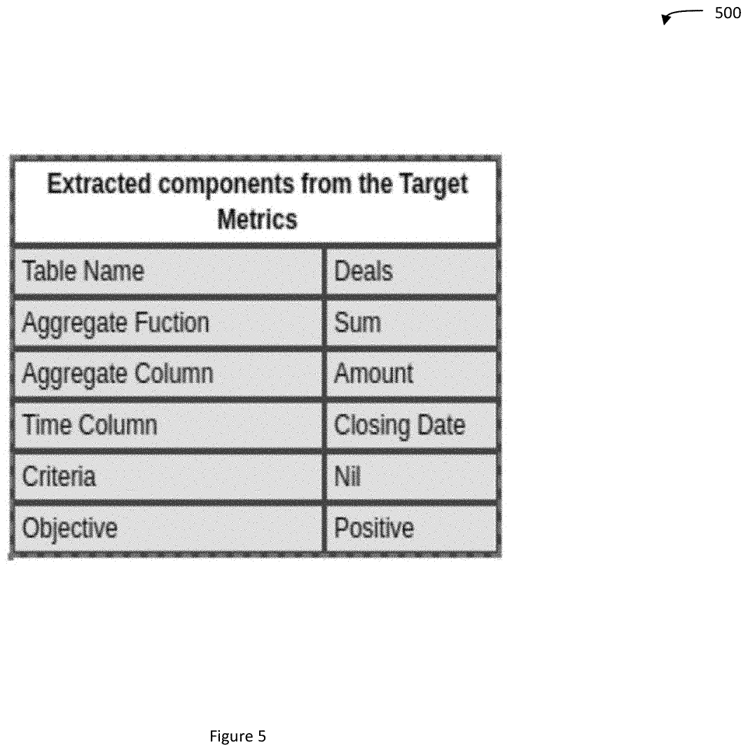

The 7 questions mentioned above are associated with revenue metrics. Revenue for a period is the “Total amount from Deals closed” (i.e., revenue). For example, [select sum (Amount) from Deals where ClosingDate=“last year”] references the revenue target metrics. Target metrics can be acquired from users through a user interface (UI) for specifying target metrics. FIG. 4 illustrates a UI for specifying target metrics suitable for this example. The UI is one example of a relatively user-friendly way to acquire relevant information, which is illustrated in FIG. 5. FIG. 5 illustrates extracted components of the target metrics, which includes Table Name (Deals), Aggregate Function (Sum), Aggregate Column (Amount), Time Column (Closing Date), Criteria (Nil), and Objective (Positive).

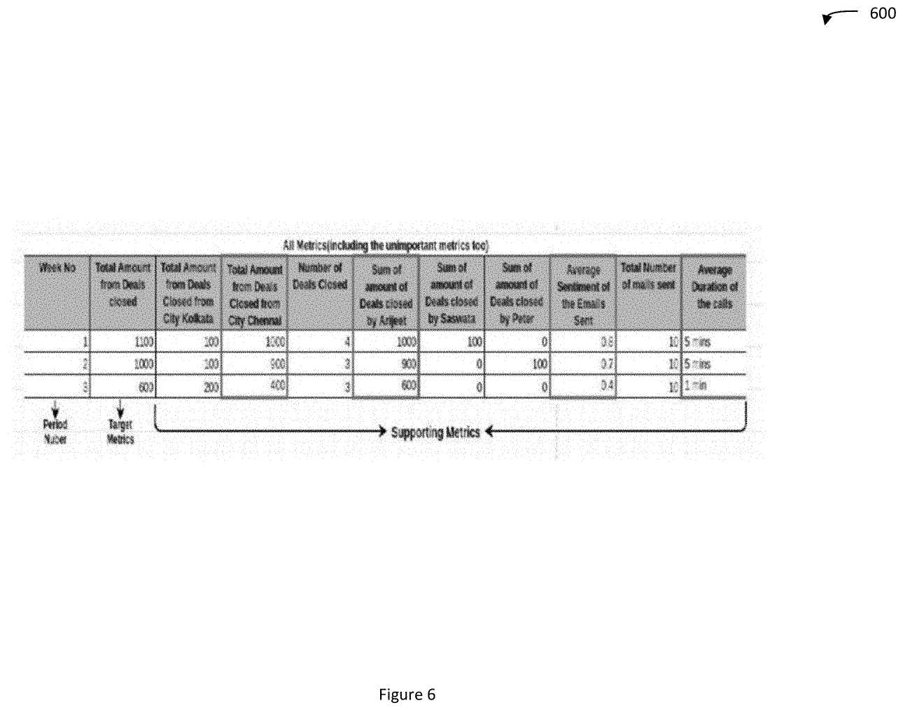

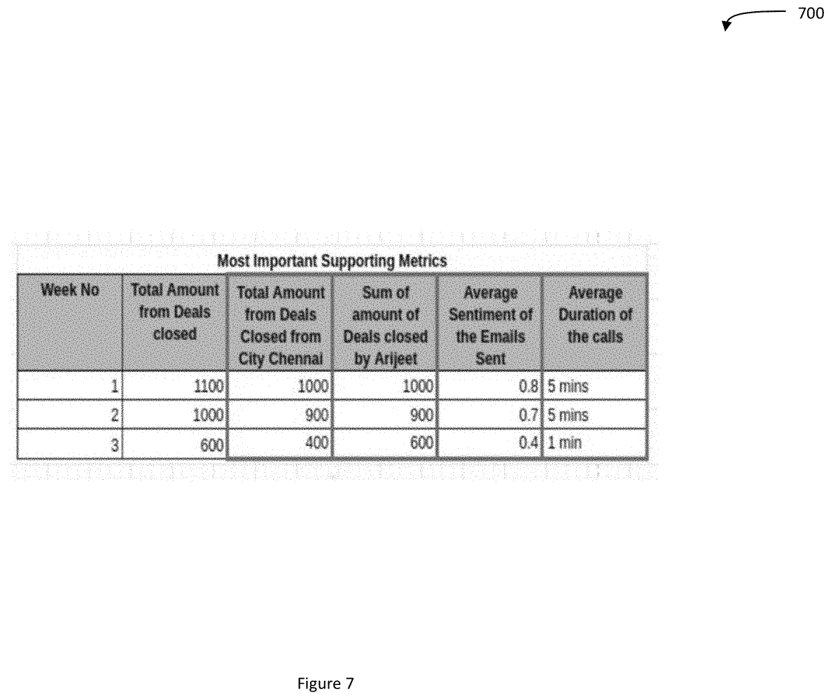

As an example, after analyzing and running statistical tests on data, the ZAAF might identify the following metrics as important supporting metrics that influence the target metrics (revenue in this example): Total Amount from Deals Closed from City Chennai; Sum of amount of Deals closed by Arijeet; Average Sentiment of the Emails Sent; and Average Duration of the calls. ZAAF uses machine learning and statistics algorithms to find supporting metrics in three phases: ZAAF first (in Phase 1) tries to find all possible metrics by scanning a datastore; for the data scenario being described by way of example, this step might find the supporting metrics illustrated in the FIG. 6. ZAAF then (in Phase 2) selects at least some supporting metrics (e.g., the most important) from all possible supporting metrics by analyzing trends in the data; examples of such supporting metrics for our target metrics are illustrated in FIG. 7. This process is described in more detail below. Finally (in Phase 3), ZAAF tries to answer those 7 questions through UI components where the explanations are based on the supporting metrics. We are going to see how each question is answered through each of the UI components that ZAAF produces with reference to a strategy planner.

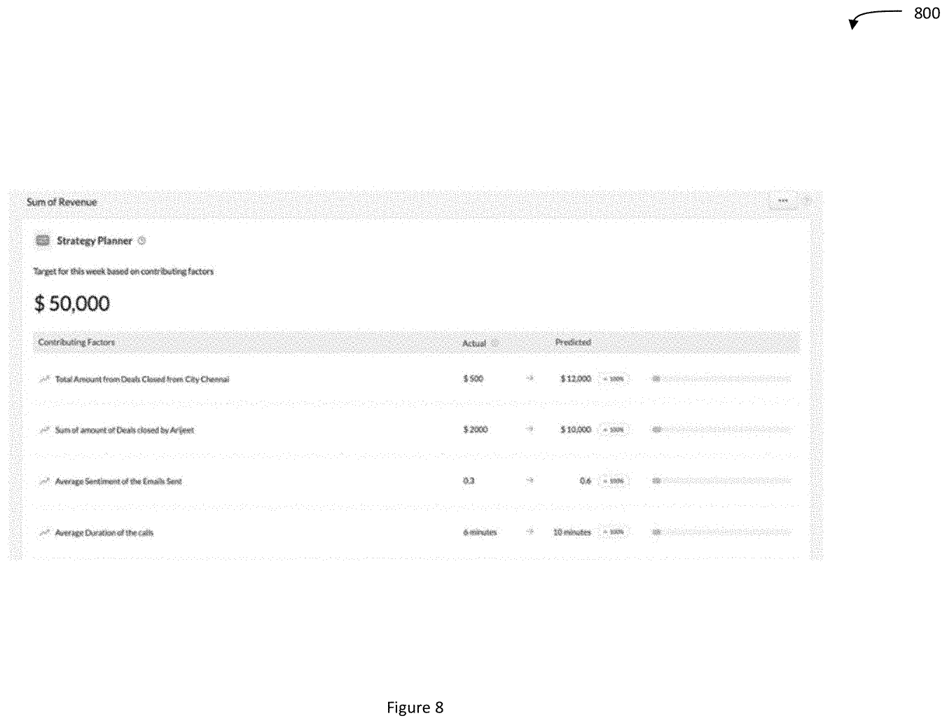

The type of questions a strategy planner can answer are 1) What is my predicted revenue for this week and how can I achieve it? 2) How much revenue Zykler can achieve if average sentiment of the Emails is improved to 0.8? 3) What should be my strategy for achieving $80,000 of revenue? A strategy planner can answer these questions by understanding the relationship between target metrics and the supporting metrics. In this example, by default, the strategy planner predicts an expected strategy for the management. A strategy is the combination of values of the supporting metrics. The predicted target metrics can also be shown to the user if those values of supporting metrics are achieved. So, in the context of Zykler Pvt Ltd, the strategy planner might answer the first question (What is my predicted revenue for this week and how can I achieve it?) with its default strategy: Select a period for which user needs the default strategy and ask the strategy planner component to show the default strategy for that period. The answer is provided in FIG. 8, which illustrates a UI diagram for default strategy for the next period. If expressed in words, it would be something like “Analyzing the past data, it looks like, in this current week a) Total amount of Deals closed from City Chennai is going to be $12000, Sum of amount of Deals closed by Arijeet is going to be $1000, Average sentiment of the mails sent by you is going to be 0.6 and the average duration of calls is going to be 10 mins. With this strategy you can expect a revenue of $50000.” Note: Here the analysis period is current week. This can be any time-period like the current month, year, etc.

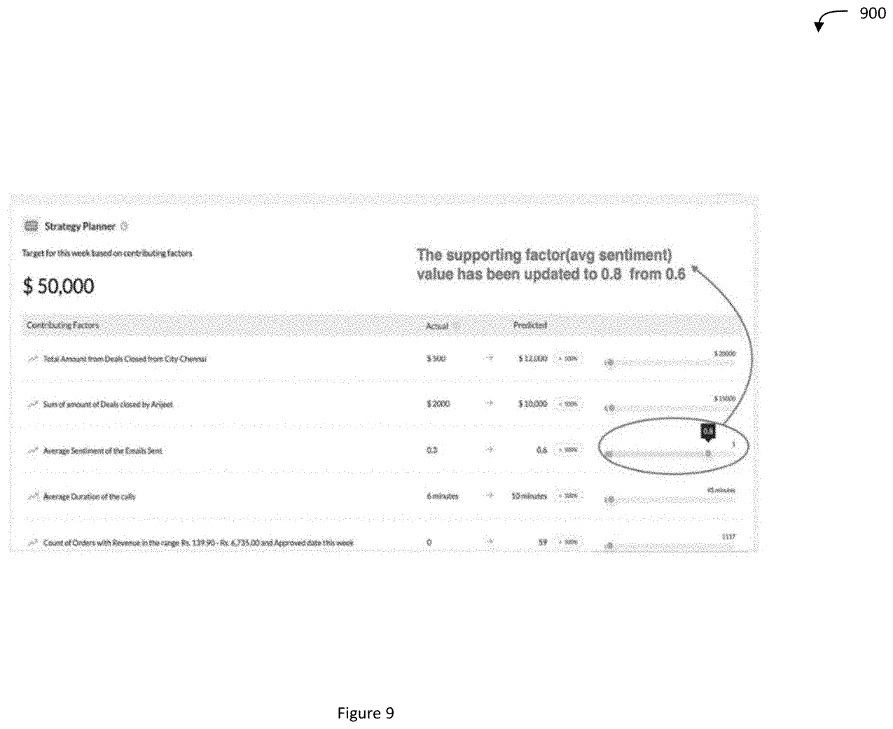

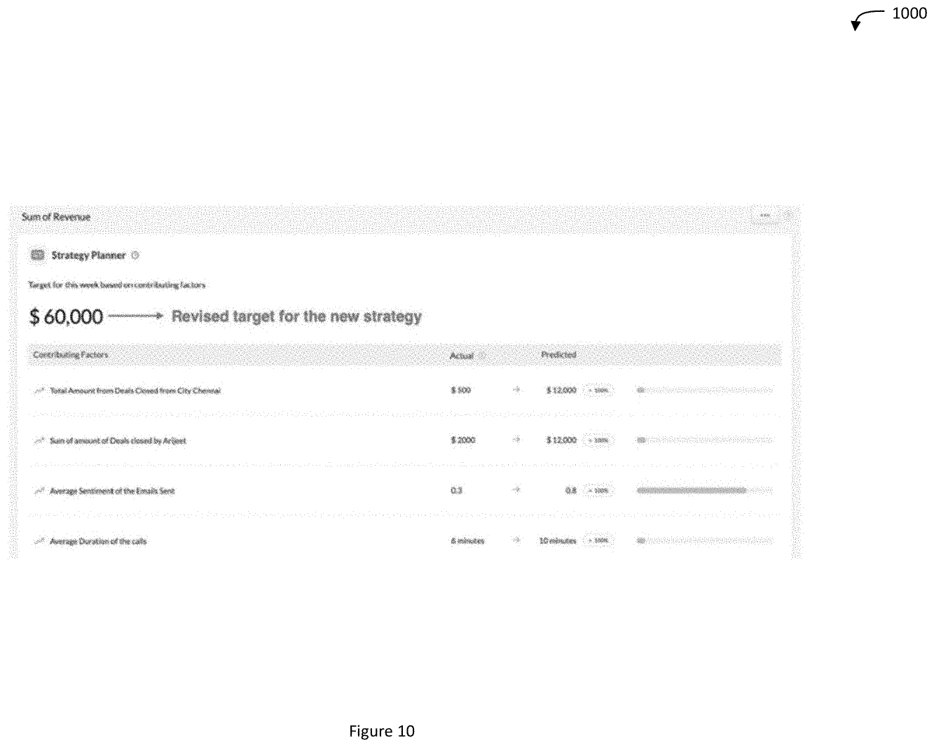

A user might have or prefer a different strategy. To generalize, a user might want to see how the target metrics is changed with a different strategy using a different set of values for supporting metrics. In the context of Zykler Pvt Ltd, a user might ask the second of the 7 questions: How much revenue Zykler can achieve if average sentiment of the Emails is improved to 0.8? For the custom strategy, a user can be instructed to change the strategy by setting the values of supporting metrics with the help of the blue sliders in the contributing factors section. FIG. 9 illustrates the UI after a user adjusts the “Average Sentiment of the Emails Sent” slider for the supporting metrics to 0.8. The answer after updating the “average sentiment of the emails sent” value, indicating the target metric is increased from $50,000 to $60,000 for the new strategy by the ZAAF is illustrated in FIG. 10.

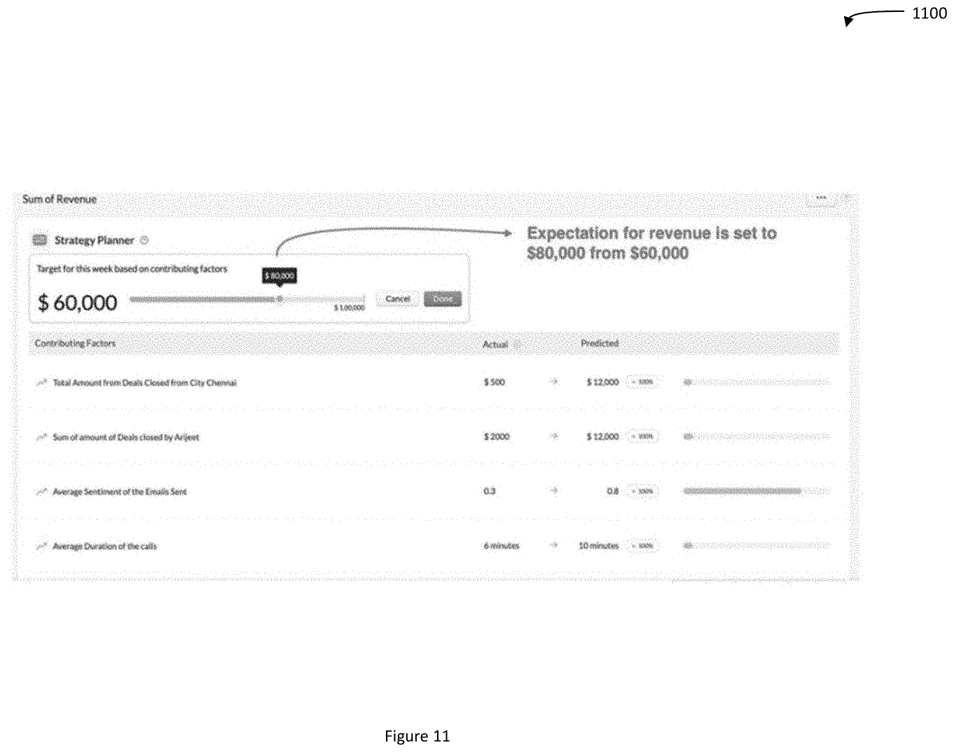

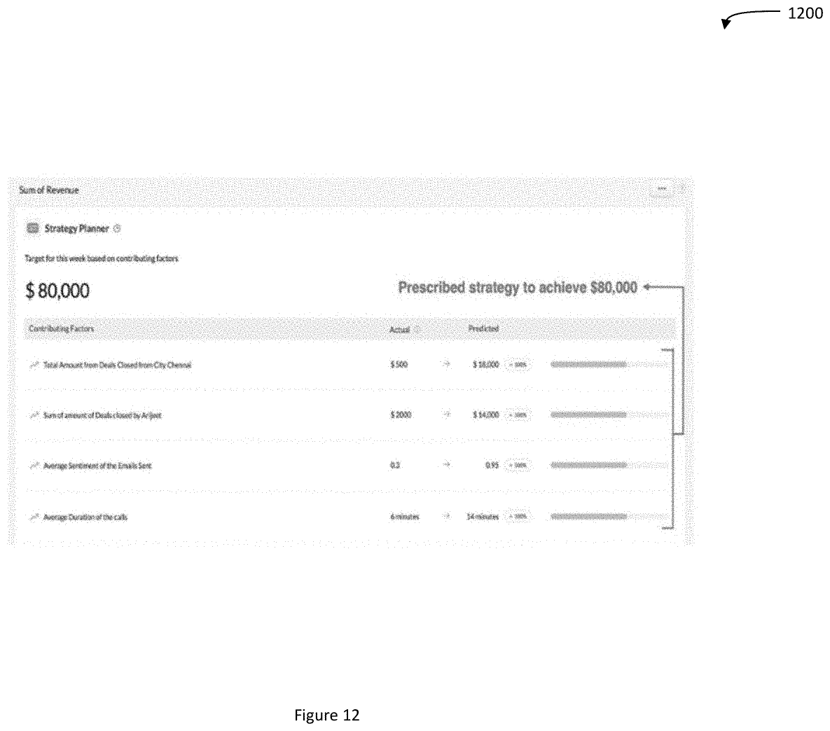

A user might want to achieve a specific target value and ask the strategy planner to chart a strategy for that. In the context of Zykler Pvt Ltd, a user might ask the third of the 7 questions: What should be my strategy for achieving $80,000 of revenue? For the custom strategy, a user can be instructed to edit the value of the target metrics to $80,000 and ask the strategy planner to suggest a strategy to achieve that target. FIG. 11 illustrates the UI after a user adjusts the “Target for this week based on contributing factors” slider. The answer after updating is illustrated in FIG. 12. In this example, the strategy planner has suggested a strategy for what should be the value of supporting metrics to achieve a revenue of $80,000. If expressed in words, it would be something like “In order to achieve a Revenue of $80,000 in the current period, Zykler Pvt Ltd should a) Achieve $18,000 total Amount from Deals closed from city Chennai; b) achieve $14,000 from the Deals closed by Arijeet; c) Average sentiment of the mails should be around 0.95; and d) Average duration of the calls should be increased to 14 minutes.”

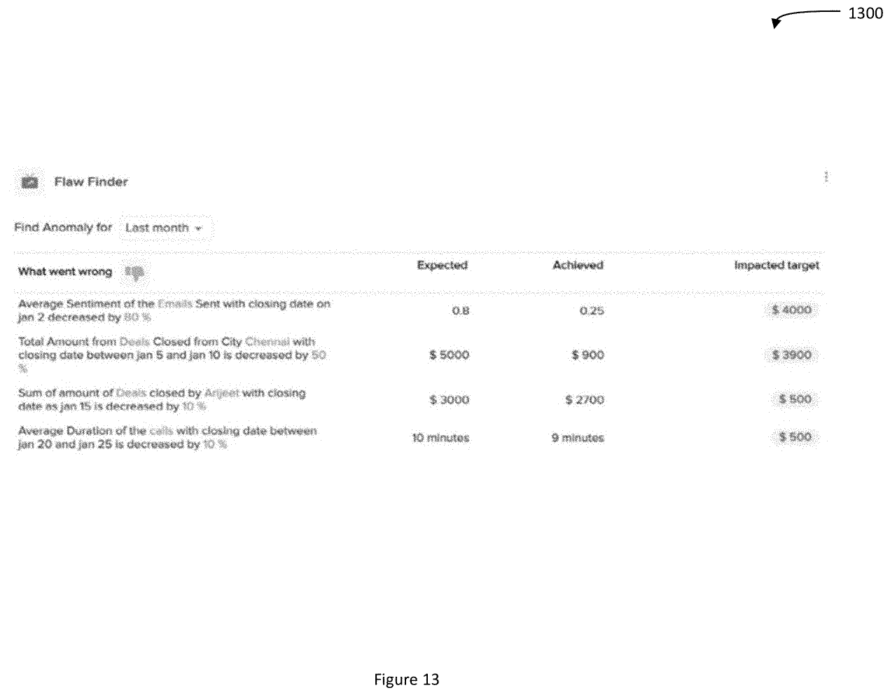

A flaw finder is a descriptive analytics component capable of determining whether there was an anomaly in the target metrics for a certain period in the past. If there was an anomaly, it would show what went wrong in that period which caused the anomaly. In the context of Zykler Pvt Ltd, a user might ask What went wrong today? or, more specifically, why was the total amount from Deals closed decreased by $20,000? For the flaw finding task, a user can be instructed to indicate the period in the past for which the analysis is to be done. FIG. 13 illustrates a potential answer to such a question. As illustrated, the flaw finder shows the reasons for why the revenue dropped by $20,000 for last month. The “What went wrong” column shows the cause of the anomaly; the “Expected” column shows what was the expected value for that supporting factor; the “Achieved” column shows the achieved value of the supporting factor for the last month; and the “Impacted Target” column shows how much revenue was affected for that reason. If expressed in words, it would be something like “One of the reasons for the revenue dip was the Total Amount from Deals between January 5 to January 10 from City Chennai decreased by 10% as it was expected to have $5000, but we achieved $900 from Chennai. For this reason, Zykler's revenue dropped by approximately $3900.”

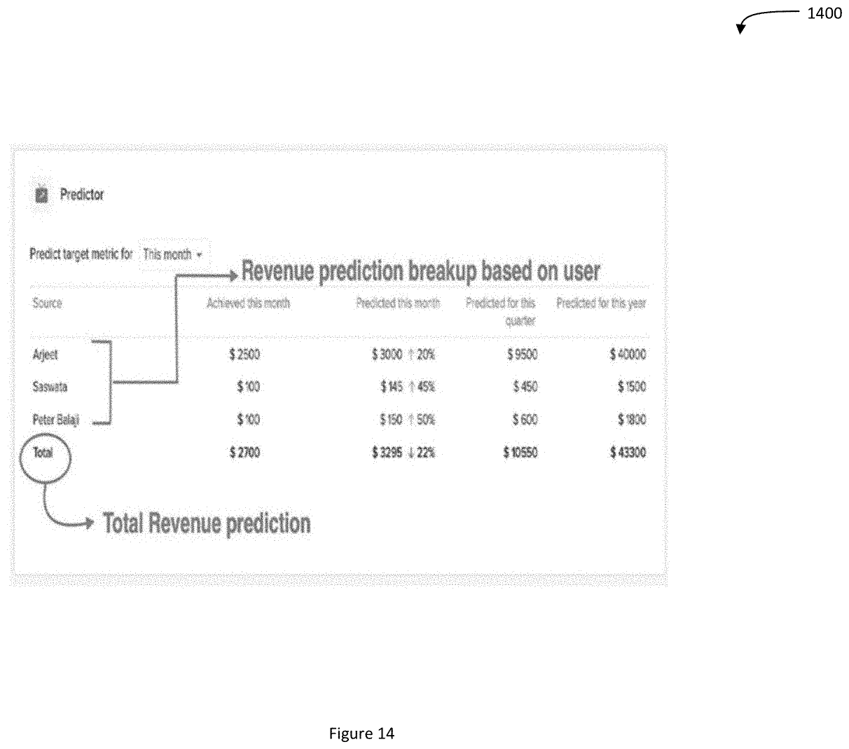

A predictor is a predictive analytics component capable of predicting the value of the target metrics for a time-period in the future by analyzing a trend. In this example, it also provides a breakdown of the predicted value for each category automatically. The categorical column based on which the breakdown is shown is also determined by the engine by considering its relevance. In the context of Zykler Pvt Ltd, user might ask the sixth of the 7 questions: What is Zykler's predicted revenue? In this example, no user action is required to get the prediction; ZAAF provides it automatically. FIG. 14 illustrates a potential answer to such a question. This component is showing the revenue projection for different periods (e.g., this month, this quarter, this year) in the future. Also, it provides the breakdown based on the source categorical field, which is the sales representative's name in this example. The engine has automatically selected the most important categorical column based on the effect it has on the variation of the target metrics (Revenue).

A prescriptor is a prescriptive analytics component capable of guiding an agent to achieve expected goals by providing suggestions or rules to be followed. For example, the prescriptor can guide a user to achieve expected revenue (target metrics) by giving suggestions or rules to be followed by the user for a given period resolution (day/week/month).

The type of questions the prescriptor can answer are: What is the predicted revenue? What should I do daily to achieve the expected revenue this week? What is the reason I was not able to achieve my expected target yesterday? How much do I need to boost revenue to compensate for yesterday's loss?

In a specific implementation, the prescriptor sets short-term goals to achieve long-term targets. For example, the prescriptor can break expected value of a given time period into a user-defined resolution (e.g., weekly). Suppose the expected revenue of this week is $1000; the “expected mode” of the prescriptor can show a user daily expected values that would achieve the prediction ($1000).

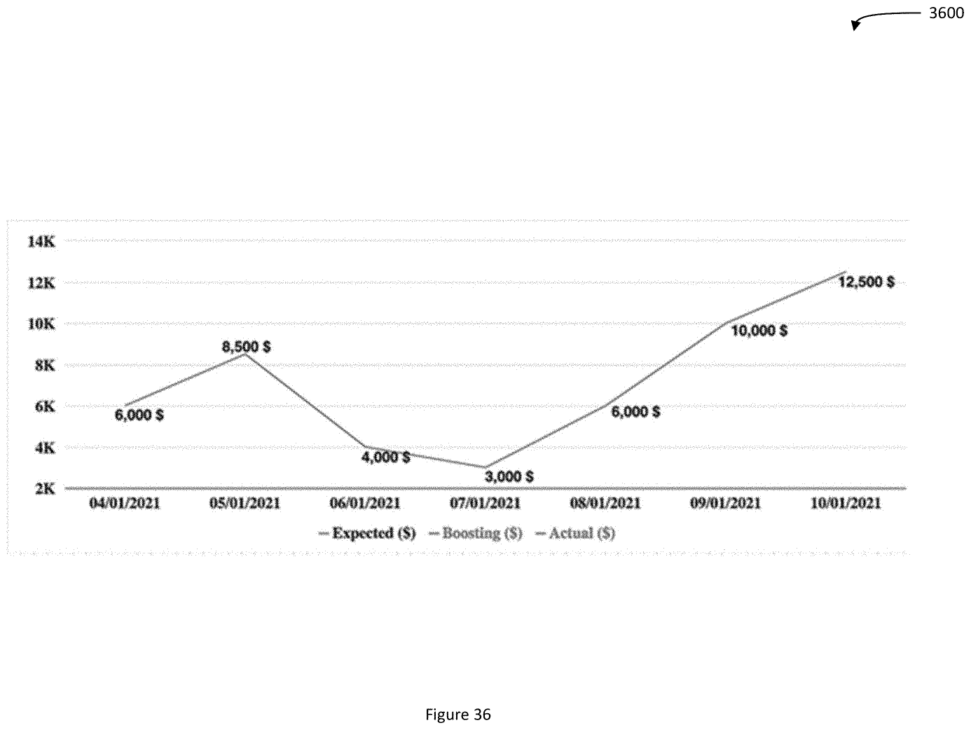

Question: “What is the predicted revenue?” For this task, a user would typically have to provide the period for which the prediction is to be done and may or may not also have to provide breakup resolution. For example, if a user needs the daily prediction value to achieve their weekly prediction, the user will choose the period type as week and resolution as daily. The output of an applicable query is shown in FIG. 36. Here, the user has selected the input period type as week and resolution as daily. The expected revenue of Zykler for this week (Jan. 4, 2021-Jan. 10, 2021) is $50,000. The prescriptor shows the daily predicted revenue of that week (i.e., $6000 revenue needs to be achieved on Jan. 4, 2021, and $8500 revenue needs to be achieved on Jan. 5, 2021. Similarly, the prescriptor shows the expected value till Jan. 10, 2021).

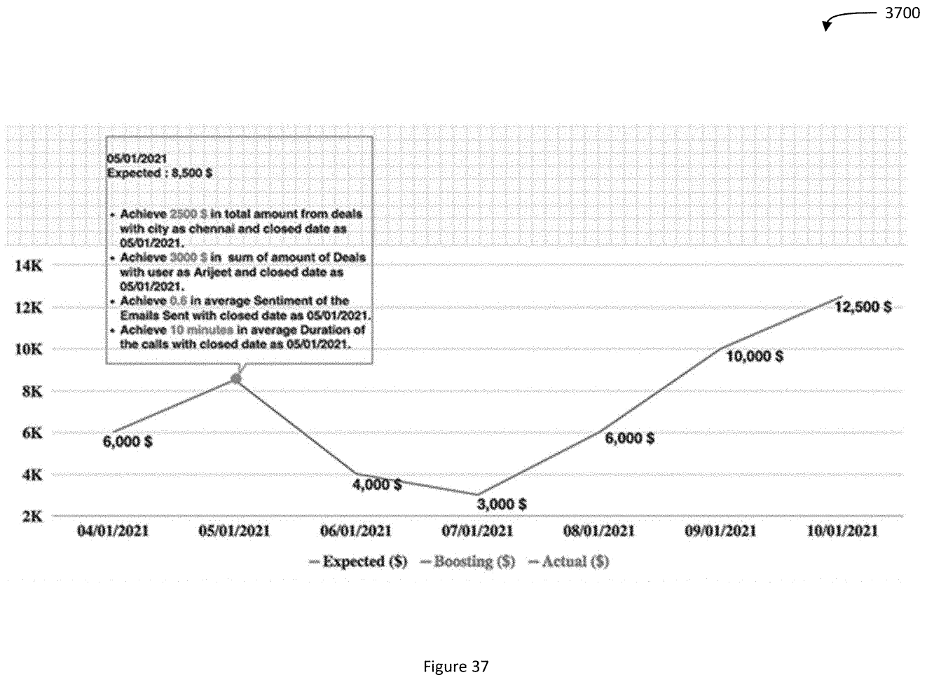

To achieve an expected target, the prescriptor will suggest a strategy to a user with user defined resolution. In a specific implementation, to answer the question, “What should I do daily to achieve the expected revenue of this week?”, a user moves a cursor over a prediction point to view a suggestion. A suitable answer is shown in FIG. 37.

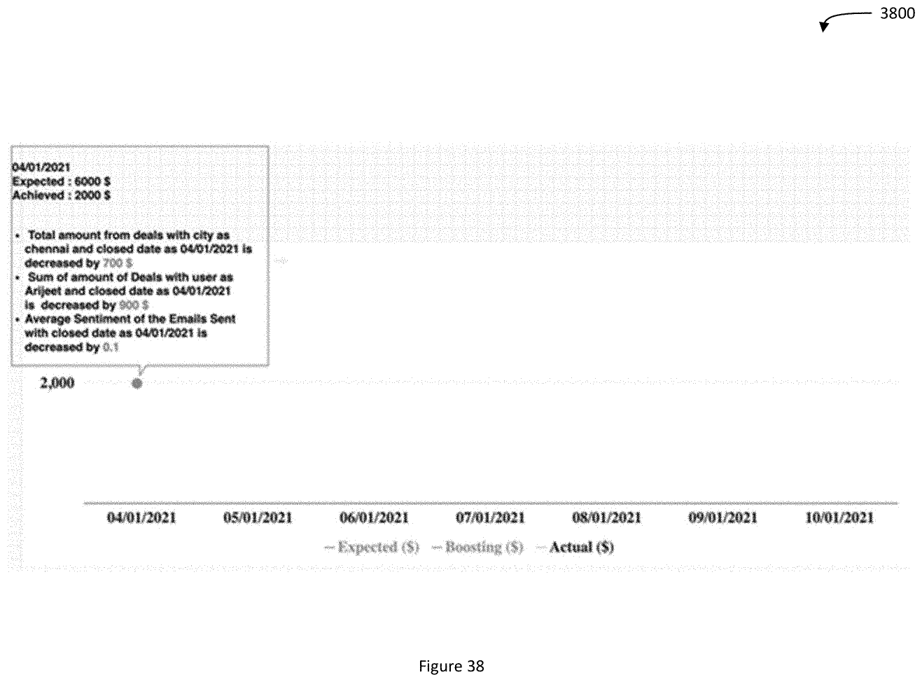

If a user is unable to achieve the expected target, the prescriptor can be used to find the major contributing reasons for the discrepancy between actual and expected value. In a specific implementation, to answer the question, “What is the reason that I wasn't able to achieve my expected target yesterday?”, a user switches to “achieved mode” and places a cursor over the data point for past days. (In this example, achieved mode is shown only for past days.) A suitable answer is shown in FIG. 38. Here expected value on Jan. 4, 2021, is $6000, but achieved value is only $2000. So, if the user is placing the cursor on data point for Jan. 4, 2021, then the prescriptor shows the major contribution reasons for that flaw (−$4000) in actual value.

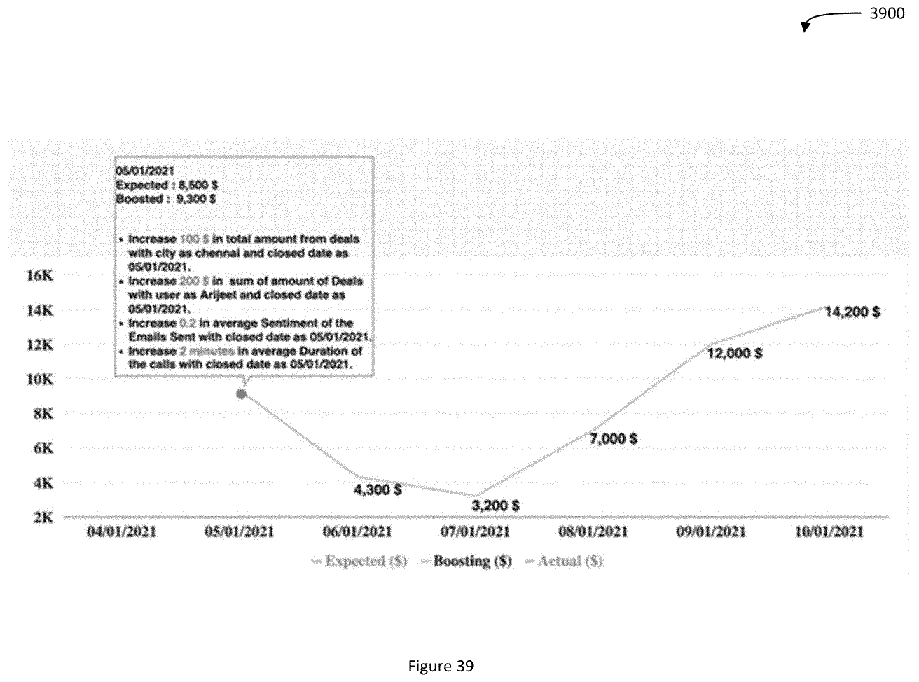

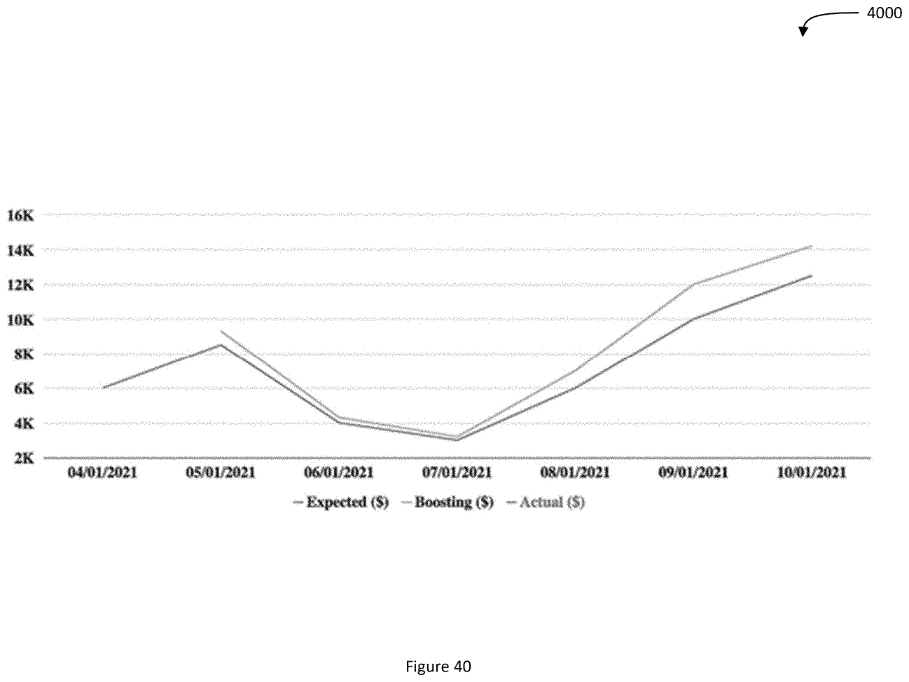

Suppose for some days, the user is unable to achieve a predicted target. To compensate for past loss, a remaining sum value (predicted−actual) can be distributed to other time periods. In a specific implementation, to answer the question, “How much of a boost in revenue do I need to compensate for yesterday's loss?”, a user switches to “boosting mode” and places a cursor over the data point for present and future data points. (In this example, boosting mode is shown only for present and future days.) A suitable answer is shown in FIG. 39. As we saw earlier, a user failed to achieve the predicted value on Jan. 4, 2021 (actual value: $2000, predicted value: $6000). In this case the remaining $800 is distributed to other days based on past data analysis. Generally, the user needs to achieve $8,500 on Jan. 5, 2021, but due to loss on Jan. 4, 2021, expected value is increased to $9300. This is known as boosting value. When the user place cursor over the boosting value, the prescriptor will show what are the improvements needed to achieve this boosting value. For example, to achieve the predicted value $8,500, user needs to get $2500 revenue from deals with city as Chennai and closing date as Jan. 5, 2021, but now to achieve the boosting value $9300, revenue from deals with city as Chennai and closing date as Jan. 5, 2021, is to be increased by $100. User can compare prediction values and boosting values by switching on both expected and boosting mode at the bottom of the graph. The comparison output is shown in FIG. 40.

ZAAF has a training phase and serving phase. During training phase ZAAF finds out one or more supporting metrics (e.g., the most important supporting metrics) and models their relationship with the target metrics. During serving, response for each of the components (Strategy Planner, Flaw Finder, Predictor, and Prescriptor) are framed with the help of the models and meta information discovered during training. So, we are going to divide the section into two parts —Training and Serving.

### Training

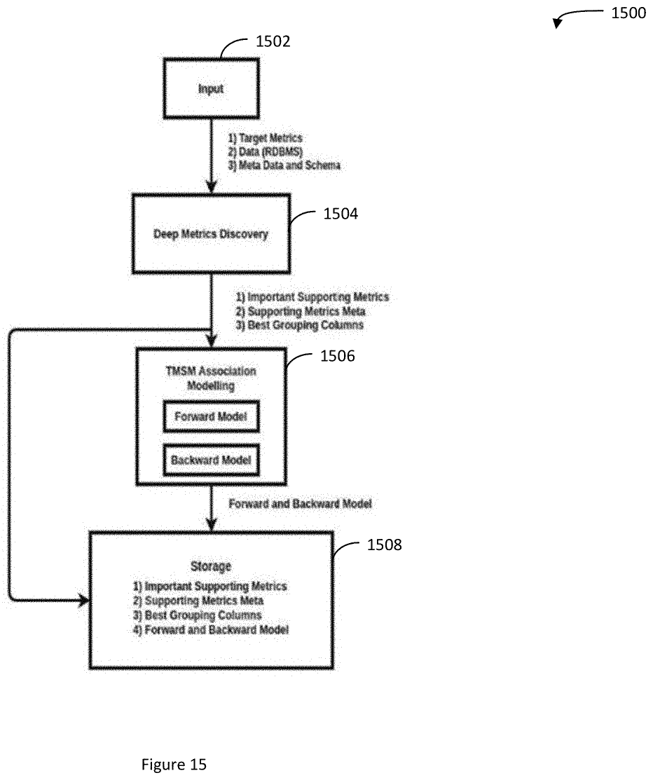

Training involves scanning RDBMS data, analyzing hidden patterns in the data, discovering the best supporting metrics with respect to target metrics and finding the relationship between target and the supporting metrics. FIG. 15 illustrates a training block diagram 1500. The diagram includes an input engine 1502, a deep metrics discovery engine 1504, a TMSM association modeling engine 1506, and a datastore 1508.

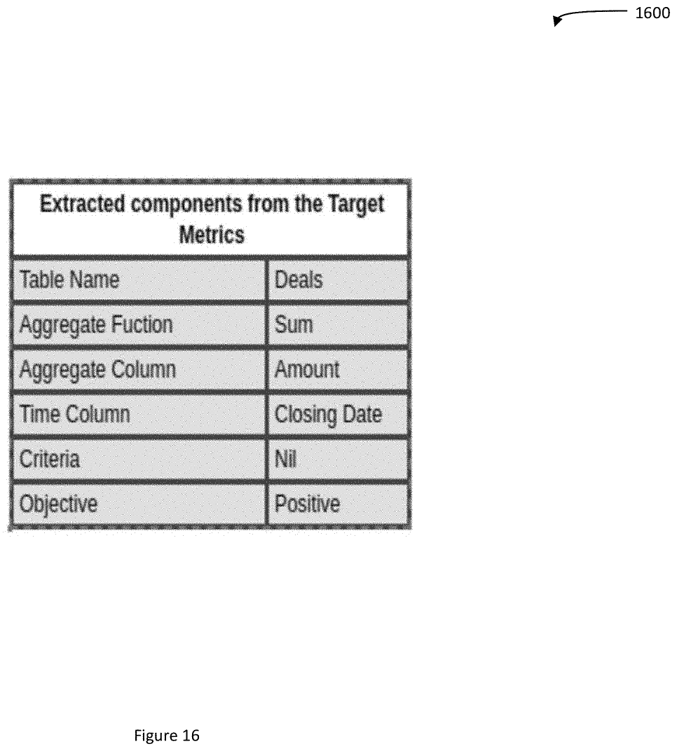

The input engine 1502 is intended to represent an engine responsible for collecting Target Metrics, Data, and Metadata and Schema. With the help of UI, ZAAF asks for the target metrics from a user around which the analysis is to be done, as was described previously. FIG. 16 illustrates extracted components from the target metrics. The data (e.g., Database Management System (DBMS) data or relational DBMS (RDBMS) data) on which the analytics is to be run includes data of all the tables needed for analysis which might contain some hidden trend; this data is injected into the framework. Along with the data, ZAAF uses metadata and schema information of the data provided which can include: Foreign key connection between tables, Primary key column information, Data type of each column of the relevant tables (the data types are numerical, categorical, date time, index (e.g. primary key)), Display Name of each column, Units (at least for numerical columns) in which the values are stored in a column (e.g. $, meters), and Format and time zone information of date columns.

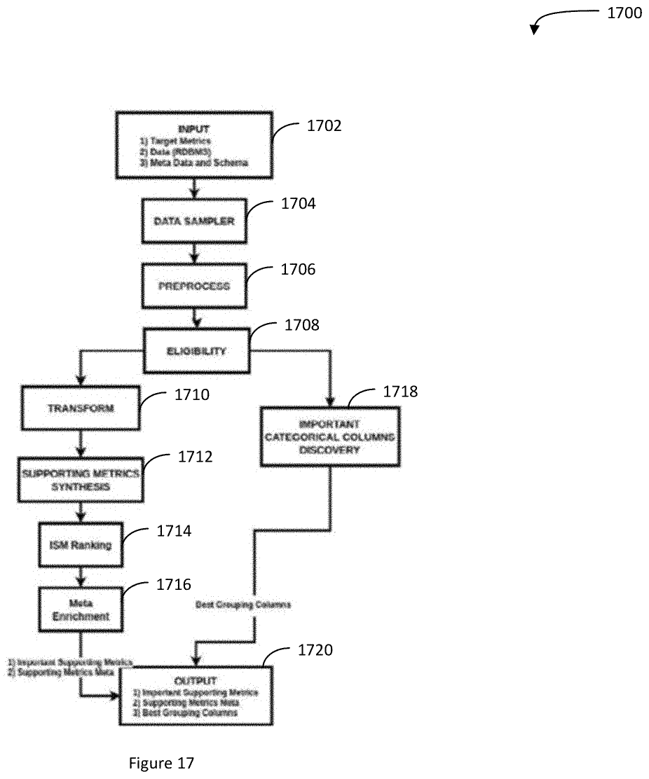

The deep metrics discovery engine 1504 is intended to represent an engine responsible for discovering at least some supporting metrics (e.g., the most important supporting metrics) by analyzing the data and metadata with respect to the target metrics. FIG. 17 illustrates a diagram 1700 of an example of a system for deep metrics discovery. The diagram includes an input engine 1702, a data sampler 1704, a preprocess engine 1706, an eligibility engine 1708, a transform engine 1710, a supporting metrics synthesis engine 1712, an important supporting metrics (ISM) ranking engine 1714, a meta enrichment engine 1716, an important categorical columns discovery engine 1718, and an output engine 1720.

The input engine 1702 is intended to represent an engine responsible for providing input to the deep metrics discovery system. In a specific implementation, the input includes Target Metrics, Data, and Metadata and schema.

The data sampler 1704 is intended to represent an engine that performs sampling. In a specific implementation, as scalability is a major concern for these kinds of engines, data is sampled from all the tables to carry out the analysis. For real time use cases, ZAAF sampling does not violate Central Limit Theorem. So, there may not be much difference in the output even though sampling is done. An example of an applicable sampling method includes: 1) First the data sampler randomly samples 0.5 million rows from the primary table (e.g., the table on which the target metrics is based); the primary table is Deals with respect to target metrics for the example data scenario. 2) From the other tables, which have a foreign key relationship with the primary table, only the related rows to the randomly sampled rows from primary table are taken. This technique is repeated for tables that are related to the related tables and so on and so forth.

The preprocess engine 1706 is intended to represent an engine that handles preprocessing and cleaning the data. It does the following: 1) It scans the meta data (data type, primary key, foreign key, etc.) provided by the input module regarding each column; 2) It formats the time columns in same format and brings them to a uniform time zone for analysis and also marks them as time columns; 3) It marks the numerical column based on metadata provided and formats them into continuous format; 4) Based on the meta-data provided, it formats the categorical columns and marks them; 5) The datatype of the columns which are not categorical, date time, numerical or primary key are marked as “others”.

The eligibility engine 1708 is intended to represent an engine that determines data eligibility. In a specific implementation, the eligibility engine 1708 is configured to check whether each column has sufficient information and eliminates those columns that are not eligible. For example, if the percentage of missing values for a numerical column crosses a threshold, the column is marked as ineligible and dropped. As another example, if the percentage of missing values for a categorical column crosses a threshold, the column is marked as ineligible and dropped; if the categorical column has very high cardinality or very low cardinality, the column is also marked as ineligible. As another example, if the percentage of missing values for a time column crosses a threshold, the column is marked as ineligible and dropped. As another example, columns that do not fall under numeric, categorical, primary key or time category are dropped. In a specific implementation, the eligibility engine 1708 is configured to determine whether enough data is present for analysis. For example, as this is a metrics driven analysis, it checks whether enough rows are present for analysis. As another example, it determines whether data is sufficiently distributed over the span of at least last one year as this is a metrics driven discovery and ZAAF tracks changes in those metrics over time. As another example, it determines whether enough eligible columns are available to perform the analysis. If some of these examples (and in a specific implementation, all) are not met, execution stops, and a user is informed that sufficient information is not present for analysis. After eligibility, the flow bifurcates. The first part (the transform engine 1710) is responsible for relevant metrics (e.g., the most important metrics) discovery and the second part (the important categorical columns discovery engine 1718) is responsible for categorical column (e.g., the most important categorical columns) discovery in the primary module.

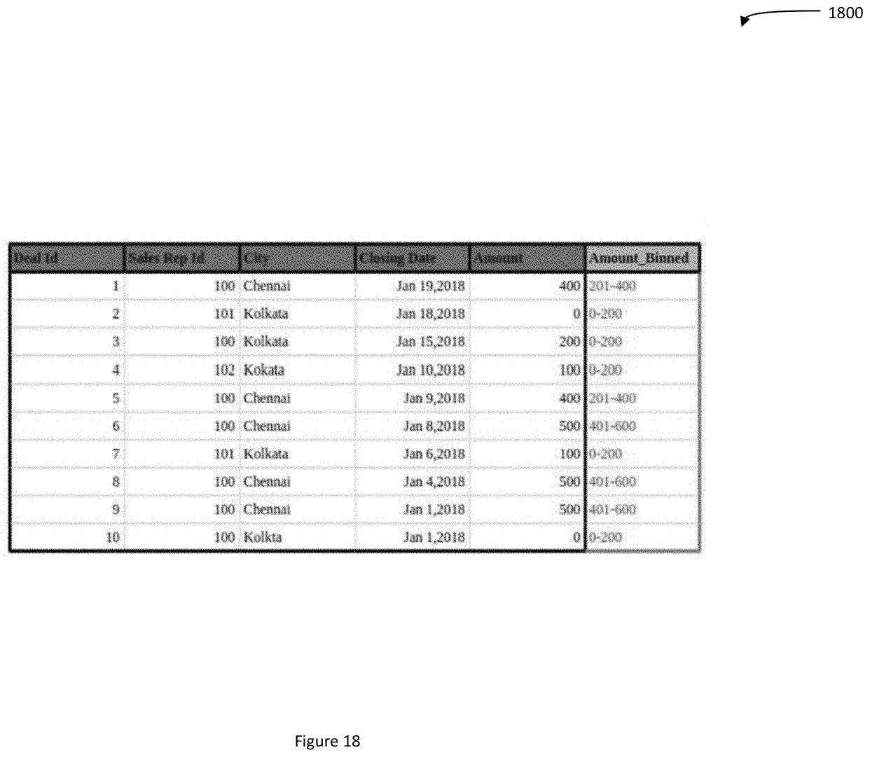

The transform engine 1710 is intended to represent an engine that generates new columns on the tables that are later utilized in supporting metrics synthesis. To achieve these artificially generated columns, each of the numerical columns are used for creating a new artificial categorical column with the help of machine learning preprocessing technique called binning. FIG. 18 illustrates a representation of an example of transformation table. In FIG. 18, an artificial column is introduced “Amount Binned”. To do that, ZAAF first determines all the numeric columns in the table. For each numeric column it applies binning and creates an artificial column for that. The binning algorithm used in this example is quantile-based discretization. Binning is a process of converting a numeric column into a categorical column. Here, Amount is a numeric column, so it has been binned, and each column is assigned a category (0 to 200, 201 to 400) based on the value in the numerical column (Amount).

The supporting metrics synthesis engine 1712 is intended to represent an engine responsible for determining supporting metrics. In a specific implantation, a strategy is to find a lot of supporting metrics and then select the best of them (ISM Ranking). Internally ZAAF extracts millions of metrics with respect to the data (e.g., all the tables). First it will be described how the supporting metrics synthesis engine 1712 discovers hidden metrics from the primary table. (For our data scenario, the Deals table is the primary table.) Then it will be described how the supporting metrics synthesis engine 1712 finds metrics from tables with many to one and one-to-many relationship with the primary table.

Assume metrics consist of Table, Aggregate Functions, Aggregate columns, Time Column and Criteria. (Objective is ignored as it is not needed for the purposes of this example.) The supporting metrics synthesis engine 1712 creates a huge list of metrics by plugging in all possible values in these components with respect to the schema. For example, it can try a lot of permutations and combinations with candidates for each component. Permutation and combination give rise to a lot of metrics from the primary table.

At this point, each column of the tables has been marked into a datatype numerical, categorical, and time. The transformed columns (the binned columns) are of data type categorical because of the nature of the transformation. We can create a lot of supporting metrics from the primary table by trying out different combinations of the candidates of the components of the metrics. We are going to look at the different candidates for each component of the metrics from the primary table, as in Table 1:

TABLE 1
Candidates for components of the metrics (Primary Table)

| Metrics Component | Candidates |
|---|---|
| Table | Primary Table Name |
| Aggregate Functions | Aggregate functions |
| Aggregate Columns | Numerical columns |
| Time Columns | Time columns |
| Criteria | Criteria that can be formed with the |
| | categorical variables and their values |

We are going to demonstrate this with our example data scenario of Deals table and see what are the candidates for each component and the resultant select query list. We have modified the data scenario a bit for this demonstration by adding a few extra columns like starting date and number of items, so our primary table—Deals looks like Table 2:

TABLE 2
Candidates for components of the metrics of the Primary Table Deals

| Metrics Component | Candidates |
|---|---|
| Table | Deals |
| Aggregate Functions | Any of MAX, MIN, AVG, SUM, COUNT |
| Aggregate Columns | [No. of Items, Amount] |
| Time Columns | [Starting Date, Closing Date] |
| Criteria | Criteria that can be formed with the categorical |
| | variables [Sales Rep Id, City, Amount Binned] |
| | and their values |

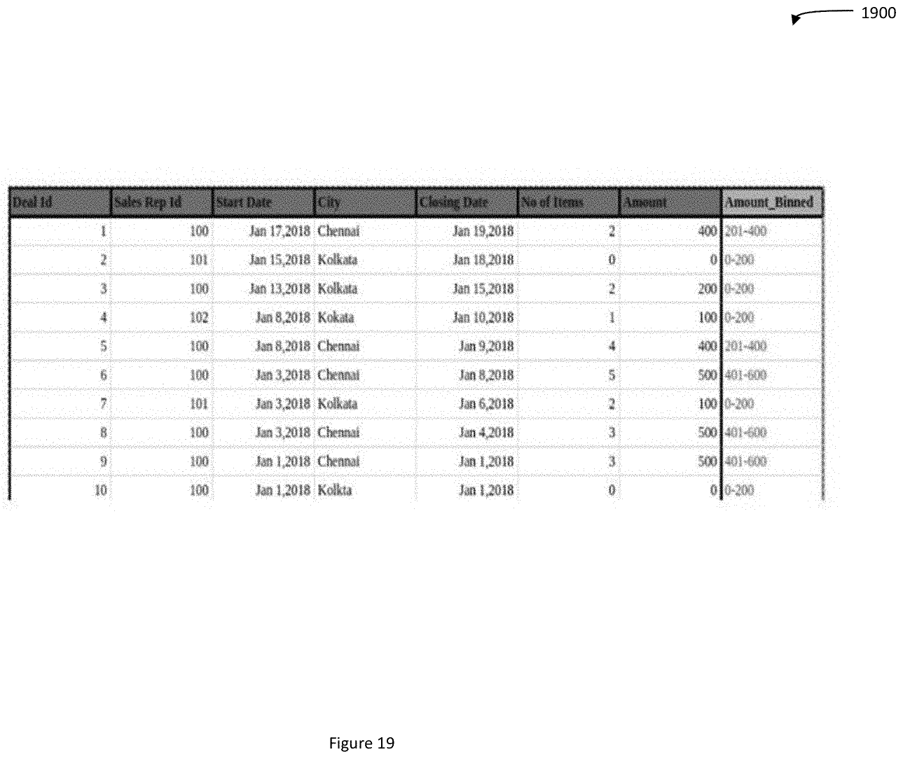

Considering the data scenario, FIG. 19 illustrates a representation of the deals table. A lot more metrics can be created from this data set itself by trying out all possible combination of these 5 components of the metrics, but it is not possible to list all possible generated support metrics as the number is huge. Some examples are: 1) Metrics by varying the aggregate function: There are 5 possible options for Aggregate function and several possible supporting metrics that can be formed by varying the aggregate function and leaving rest of the components constant, such as Sum of Amount of Deals Closed last week, Count of Deals Closed last week, Maximum amount from a Deal Closed last week, and Minimum amount from a Deal closed last week; 2) Metrics by varying the aggregate column: There are two candidate values for Aggregate columns—{Amount, Number of items} in this example and several possible supporting metrics that can be formed by varying the aggregate column and leaving the rest of the components constant, such as Average of Amount of Deals Closed last week and Average Number of items sold per Deals closed last week; 3) Metrics by varying the Time Column: There are two candidate values for Aggregate columns—{Starting Time, Closing Time} in this example and several possible supporting metrics that can be formed by varying the time column and leaving the rest of the components constant, such as Average Amount from Deals Closed last week and Average Amount from Deals Started last week; 4) Metrics by varying the criteria: There are three candidate values for Criteria columns—{Sales Rep Id, City, Amount binned} in this example and several possible supporting metrics that can be formed by varying the candidate categorical columns and their values and leaving other parts of the query constant, such as Sum of Amount from Deals with City Chennai, Sum of Amount from Deals with City Kolkata, Sum of Amount from Deals from Sales Rep Saswata, Sum of Amount from Deals from Sales Rep Arijeet, Sum of Amount from Deals where the amount is between $0 to $200, Sum of Amount from Deals where the amount is between $200 to $400, etc.

First order related tables are those tables which have a foreign key connection with the primary table. For our example data scenario, the first order related tables are User, Calls and Emails tables. There might be second order related tables which are nothing but related tables to the first order related tables. Similarly, there can be nth order related tables. In this section we are going to demonstrate with an example how we are discovering the metrics from a first order related table and then extrapolate the same concept to nth order. There are two scenarios here—one-to-many and many-to-one. We are going to see how supporting metrics is discovered for each category.

When a primary table has many rows pointed towards one row of a related table, the primary table can be characterized as having a many-to-one relationship with the related table. For our case study, the Deals table has a many to one relationship with the Users table. In case of this type of relationship the primary table is joined with the related table on the foreign key relationship and the resultant view is treated as a single table on which the same supporting metrics discovery technique is applied which we used in the supporting metrics discovery for primary table with a bit of restriction. The candidates for the metric components for the many to one relationship are mentioned in Table 3.

TABLE 3
Candidates for components of the supporting metrics related to Many-to-One scenario

| Metrics Component | Candidates |
|---|---|
| Table | Primary Table name joined related table |
| Aggregate Functions | Any of MAX, MIN, AVG, SUM, COUNT |
| Aggregate Columns | Numerical columns from primary table |
| Time Columns | Time columns from primary table |
| Criteria | Criteria that can be formed with the categorical columns from the |
| | related table and their values |

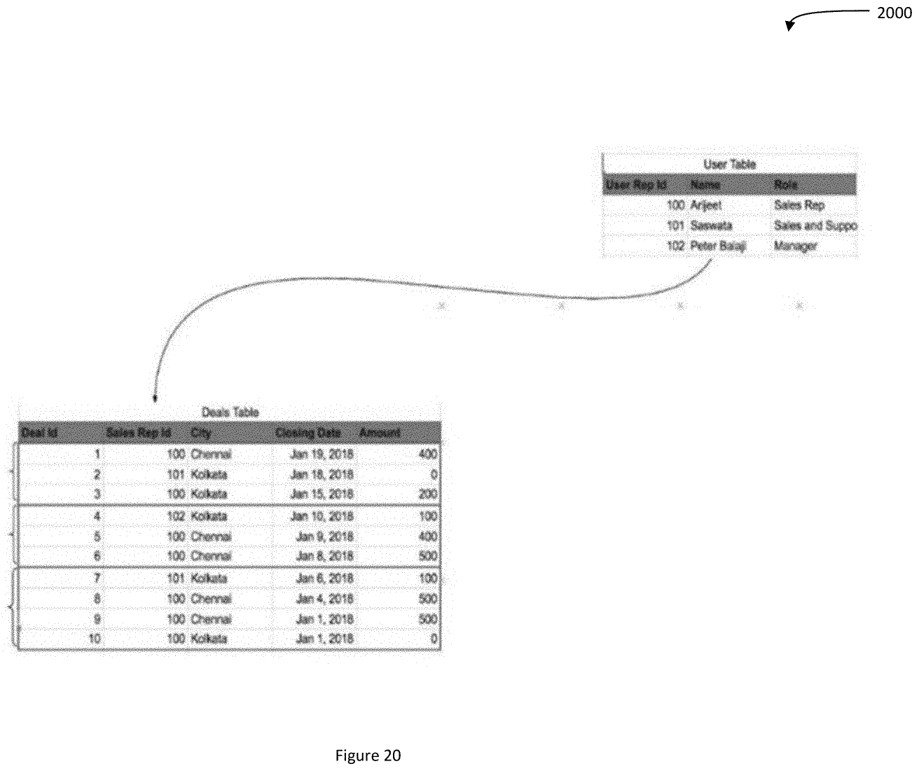

We are going to elaborate this with an example based on the example data scenario. In that example, the Deals table has a first order many to one relationship with related table User. So now we are going to see how we discover supporting metrics from the related module User. Considering our data scenario, FIG. 20 illustrates an example of a many to one relationship table.

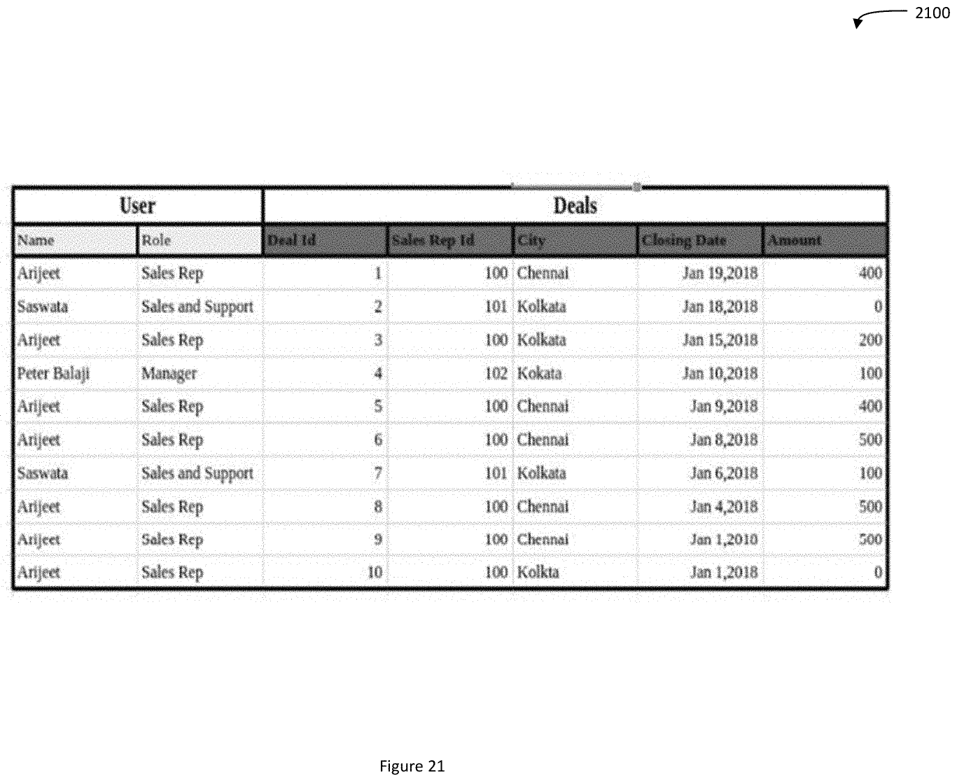

To extract supporting metrics from the first order related tables we first join these two tables based on the foreign key relationship. FIG. 21 illustrates the result after joining the tables. After joining it looks like a single table. We can apply the same Supporting metrics discovery technique which we used in the primary module section with a bit of restriction and it is shown in Table 4.

TABLE 4
Candidates for components of the metrics for this Many-to-One relationship

| Metrics Component | Candidates |
|---|---|
| Table | Deals joined User |
| Aggregate Functions | Any of MAX, MIN, AVG, SUM, COUNT |
| Aggregate Columns | [Deals.Amount] |
| Time Columns | [Closing Date] |
| Criteria | Criteria that can be formed with [Users.Name, Users.Role] |
| | and their values |

Now we can try out all possible combinations of those candidates to discover the supporting metrics related to User table. A few examples of those discovered Supporting Metrics are: 1) Total Amount from Deals closed where User Role is Sales and Support; 2) Average amount of the Deals closed where User Name is Arijeet and Deals City is Chennai; 3) Maximum amount from a Deal where User Role is a manager; 4) etc.

When a one row of the primary table is pointed towards many rows of a related table, we say that the primary table is having one-to-many relationship with the related table. For our case study, the Deals table is having a one-to-many relationship with the Emails table. In case of this type of relationship primary table is joined with the related table on the foreign key relationship and the resultant view is treated as a single table on which the same supporting metrics discovery technique is applied which we used in the supporting metrics discovery for primary module with a bit of restriction which is a bit different from many to one relationship. The candidates for the metric components for one-to-many relationship are shown in Table 5.

TABLE 5
Candidates for components of the supporting metrics related to One-to-Many scenario

| Metrics Component | Candidates |
|---|---|
| Table | Primary Table name joined related table |
| Aggregate Functions | Any of MAX, MIN, AVG, SUM, COUNT |
| Aggregate Columns | Numerical columns from related table |
| Time Columns | Time columns from primary table |
| Criteria | Criteria that can be formed with categorical columns from both |
| | primary and related table and their values |

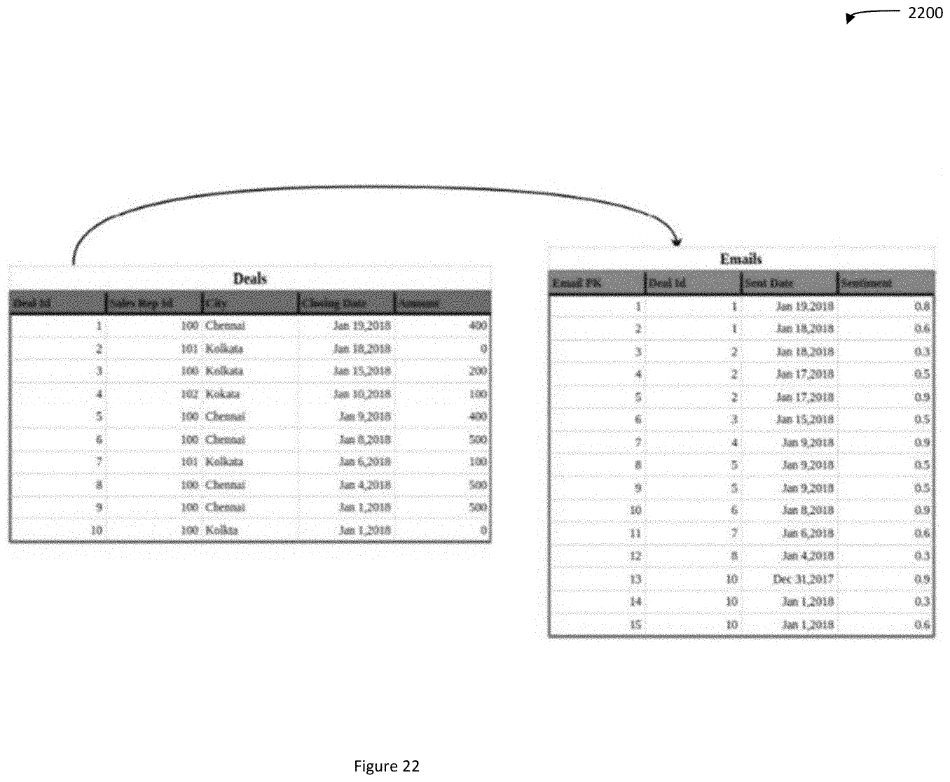

We are going to elaborate this with an example based on the example data scenario. In that example, the Deals table has a first order one-to-many relationship with related table Emails. So now we are going to see how we discover supporting metrics from the related emails. Considering our data scenario, FIG. 22 illustrates a representation of an example of a one-to-many relationship table.

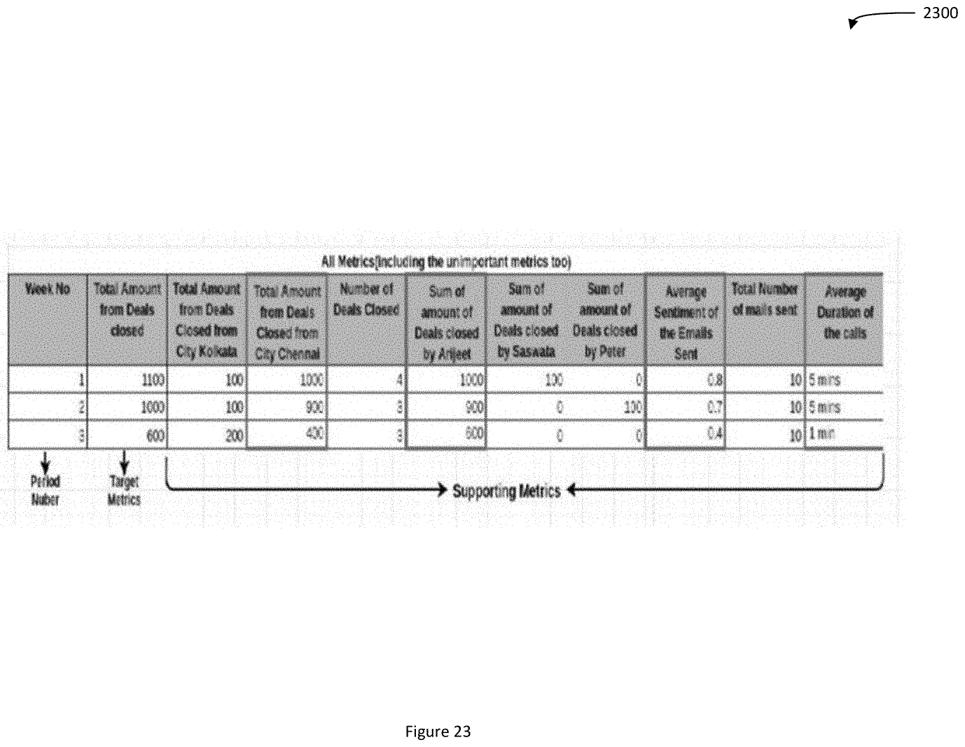

To extract supporting metrics from the first order related tables we first join these two tables based on the foreign key relationship. After joining it looks like a single table. We can apply the same Supporting metrics discovery technique which we used in the primary module section with a bit of restriction. FIG. 23 shows the resultant table after joining the one-to-many relationship entities and it is shown in Table 6.

TABLE 6
Candidates for components of the metrics for this to One-to-Many relationship

| Metrics Component | Candidates |
|---|---|
| Table | Deals joined User |
| Aggregate Functions | Any of MAX, MIN, AVG, SUM, COUNT |
| Aggregate Columns | [Emails.Sentiment] |
| Time Columns | [Deals.Closing Date] |
| Criteria | Criteria that can be formed with [Deals.City, Deals.SalesRepId] |
| | and their values |

Now we can try out all possible combinations of those candidates to discover the supporting metrics related to Calls table. A few examples of those discovered Supporting Metrics are: 1) Average sentiment of the emails for the Deals closed last week; 2) Average Sentiment of the Mails sent from the Deals closed which are from Chennai; 3) Average Sentiment of the Mails sent from the Deals closed which were handled by Saswata; 4) etc.

We have seen how metrics are extracted from the primary table and a first order related tables with one-to-many and many-to-one relationships. For each of the first order related table we extract metrics by joining that with the primary table and treating the whole joined view as a single table and then extract metrics with respect to the candidate values applicable to the type of relationship between the tables.

For the second order related tables, we also apply the same approach of joining to make it look like a single table where we can apply the same supporting metrics discovery technique. To get the joined view of the second order table we join three tables to establish the relationship—primary table joined with a first order table joined with a second order table. And we can apply this logic till nth order. Finally, ZAAF clubs all the supporting metrics discovered from each of the table. Practically the number of discovered supporting metrics goes in the range of millions. Note: For easier understanding we have listed out those metrics in terms of display text, but the output of supporting metrics synthesis engine 1712 is a list of select queries which are a representation of the supporting metrics in the language of a developer.

The ISM ranking engine 1714 is intended to represent an engine that discovers and ranks metrics in terms of their importance so the best supporting metrics can be selected. To rank the metrics a temporal analysis is carried out to check the correlation between the target metrics and supporting metrics over time. Let us say that the supporting metrics found out by the supporting metrics synthesis engine 1712 are 1) Total Amount from Deals closed; 2) Total Amount from Deals Closed from City Kolkata; 3) Total Amount from Deals Closed from City Chennai; 4) Number of Deals Closed; 5) Sum of amount of Deals closed by Arijeet; 6) Sum of amount of Deals closed by Saswata; 7) Sum of amount of Deals closed by Peter; 8) Average Sentiment of the Emails Sent; 9) Total Number of mails sent; and 10) Average Duration of the calls. Now we are going to see how ISM ranking is carried out with the below-mentioned steps with the help of the above example.

Step 1: The optimum analysis time-period is determined based on the data availability so that temporal analysis can be executed. In a specific implementation, if a huge amount of data is present then a weekly time-period is selected, otherwise daily period is selected. In case of our example we selected analysis period as weekly.

Step 2: Based on the analysis time period (determined in step 1) a timeline of period is listed with respect to the data. With respect to our data scenario our data spans from Jan. 1, 2018, to Jan. 19, 2018. As our selected analysis period is weekly, our timeline of period looks like this: Period 1 (Jan. 1, 2018, to Jan. 7, 2018); Period 2 (Jan. 8, 2018 to Jan. 14, 2018); Period 3 (Jan. 15, 2018 to Jan. 21, 2018).

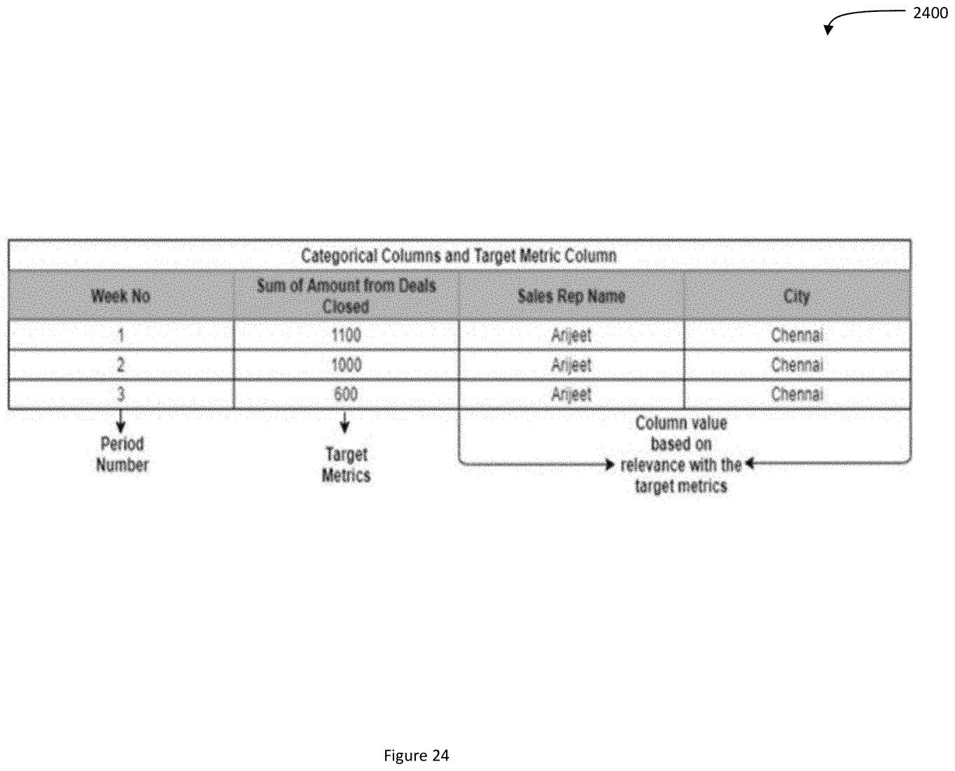

Step 3: Now for target metrics and each of those supporting metrics (provided by the supporting metrics synthesis engine 1712), values are listed for each time period. For our example data scenario, values of all those 10 supporting metrics are being noted for each of those 3 periods. A visual representation is show in FIG. 24.

Step 4: Now the ISM ranking engine 1714 finds out the Spearman correlation value between the target metrics and each of the supporting metrics. Spearman correlation between two metrics is calculated by passing all the values of the two metrics (e.g., over all the periods). With respect to our data scenario the Spearman correlation between “Total Amount from Deals closed” and “Average Sentiment of the Emails Sent”=SpearmanCorr([1100, 1000, 600], [0.8, 0.7, 0.4]). In that way Spearman Correlation value is calculated for each of the supporting metrics against the target metrics. For our data scenario, the result of this step can be represented as shown in Table 7.

TABLE 7
Spearman Correlation

| | | Spearman |
|---|---|---|
| Supporting Metrics | Target Metrics | Correlation |
| Total Amount from Deals Closed from City | Total Amount from Deals Closed | 0.42 |
| Kolkata | | |
| Total Amount from Deals Closed from City | Total Amount from Deals Closed | 0.85 |
| Chennai | | |
| Number of Deals Closed | Total Amount from Deals Closed | 0.6 |
| Sum of amount of Deals closed by Arijeet | Total Amount from Deals Closed | 0.9 |
| Sum of amount of Deals closed by Saswata | Total Amount from Deals Closed | 0.4 |
| Sum of amount of Deals closed by Peter | Total Amount from Deals Closed | 0.4 |
| Average Sentiment of the Emails Sent | Total Amount from Deals Closed | 0.8 |
| Total Number of Emails Sent | Total Amount from Deals Closed | 0.5 |
| Average Duration of Calls | Total Amount from Deals Closed | 0.75 |

Step 5: Contribution to the target of the eligible supporting metrics is calculated.

Step 6: Metrics important score for each supporting metrics is calculated with respect to the target. Metrics importance score is a function of Spearman's correlation (Step 4) and Contribution to target value (Step 5).

Step 7: Supporting metrics are then sorted based on their score and supporting metrics with top score is selected.

The meta enrichment engine 1716 is intended to represent an engine that generates supporting metrics meta information about the shortlisted supporting metrics. Display Name Enrichment considers metrics essentially to be a query, so the supporting metrics can be characterized as select queries that have been outputted by the supporting metrics synthesis engine 1712. To display that to the user we need to generate a display name to the user. For that ZAAF uses a hybrid NLG algorithm (hybrid of rule-based and template-based approach) to convert the select query into text. An example SQL to text conversion is: Select Query=select sum (Amount) from Deals where City=‘Chennai’ Display Name=“Total Amount from Deals from the city Chennai”.

Unit Enrichment is accomplished by ZAAF generating the Unit of the supporting metrics by analyzing subcomponents of the select query and the meta information about each table columns. An example is: The unit of “Sum of amount from Deals with city Chennai” is $(dollars). Here the metrics unit is dollars as the unit of the Amount column is also dollars and we are summing over that column. In this way the engine analyses the meta information to infer the unit of the metrics.

The range of a supporting metrics is the possible upper limit and lower limit of the metrics value over which it can range. This is calculated with the help of a custom algorithm which considers the mean, standard deviation of the metrics over a few time-periods in the past. It also takes into consideration the nature of the metrics. For example, Count of Deals closed cannot be lower than zero. An example is: Range for “Sum of Amount from Deals closed from City Chennai” is (0 to 2000) for weekly analysis. Here, upper limit of 2000 and lower limit 0 are calculated based on the spread of this metrics over weekly time periods in the past and considering it cannot go below zero as sum of positive numbers (Amount) cannot go below zero.

The rank of the supporting metrics is the importance ranking with respect to the target. This rank is calculated based on the importance score provided by the ISM ranking engine 1714.

The select query of the metrics generated by the supporting metrics synthesis engine 1712 is also saved with the meta information. In a specific implementation, the select query with which the metrics can be queried from the RDBMs is saved in a JSON format.

The spearman's correlation coefficient which had been derived in step 6 of ISM ranking for the supporting metrics is also saved. At the end of the training, ZAAF saves all meta information for all the supporting metrics discovered by the engine so this information can be used by the serving module.

Having discussed the flow mentioned on the left (engines 1710 to 1716), we are now going to look at the right side. The important categorical columns discovery engine 1718, which bifurcates from the eligibility engine 1708, is intended to represent an engine responsible for flow of deep metrics discovery. In a specific implementation, the important categorical columns discovery engine 1718 generates a list of most important categorical/grouping columns in the primary table and the most important values in them. For our example data scenario, the output of the important categorical columns discovery engine 1718 can be characterized as “The most important categorical/grouping column in the primary table Deals is Sales Rep Name (out of the categorical columns City and Sales Rep Name). For Sales Rep Name column the most important values sorted in terms of their importance are Arijeet, Saswata and Peter”. As an example of how to do that, the important categorical columns discovery engine 1718 first finds the most important categorical/grouping column in the primary table and then it finds out a sorted list of the values of the most important categorical/grouping column in terms of importance with respect to the target metrics.

Now we will describe the steps of finding the most important categorical/grouping columns based on the order of importance to the target metrics. Assuming the case study mentioned above, the categorical columns in the Deals table are City and Sales Rep Name. To determine the most important categorical/grouping column, the following steps can be done.

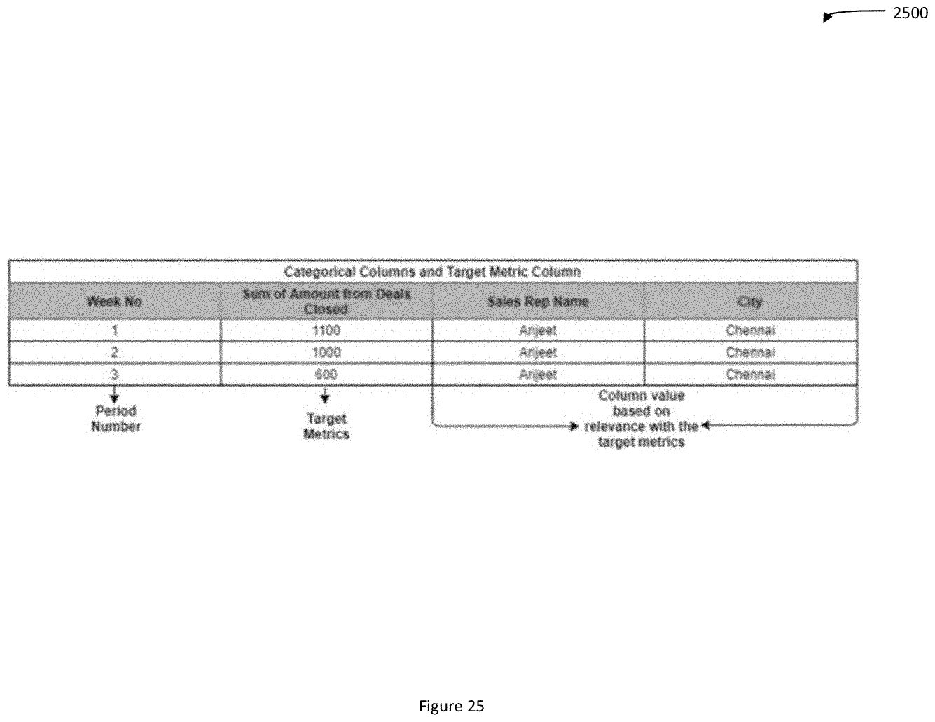

Step 1: For each of the categorical columns of primary table, the highly preferred value of that categorical column concerning the target metrics is listed for each period in the timeline of the periods. For example, in our case study data scenario, a column value is chosen for each of those three periods for every categorical column based on its relevance with the target metrics value. An illustration of the data is given in FIG. 25.

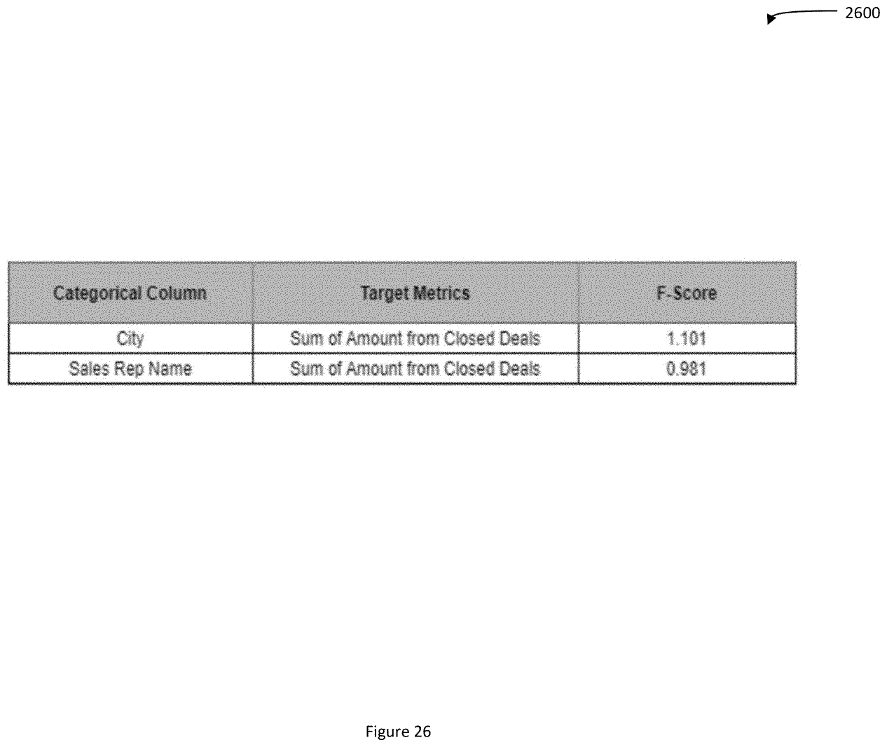

Step 2: Once the data is listed, an ANOVA test is performed between each categorical column and the target metrics. ANOVA is performed by passing the categorical column values and the target metrics values over all the periods. In correspondence with our case study data scenario, the ANOVA test between Sum of Amount from Deals Closed and Sales Name Rep (Label Encoded) is found by ANOVA([1100, 1000, 600], [1, 1, 1]), which returns an F-Score. The resultant of this step is illustrated in FIG. 26.

Step 3: Important categorical/grouping columns are selected based on the F-score, and the categorical columns with a higher score are considered ahead in the order of importance.

After the most important categorical column is determined, the important categorical column values are determined. Let us assume that the categorical column Sales Rep Name has been picked as an important categorical column, and the column values in column Sales Rep Name are Arijeet, Saswata, and Peter. The determination of the important categorical column values involves the following steps.

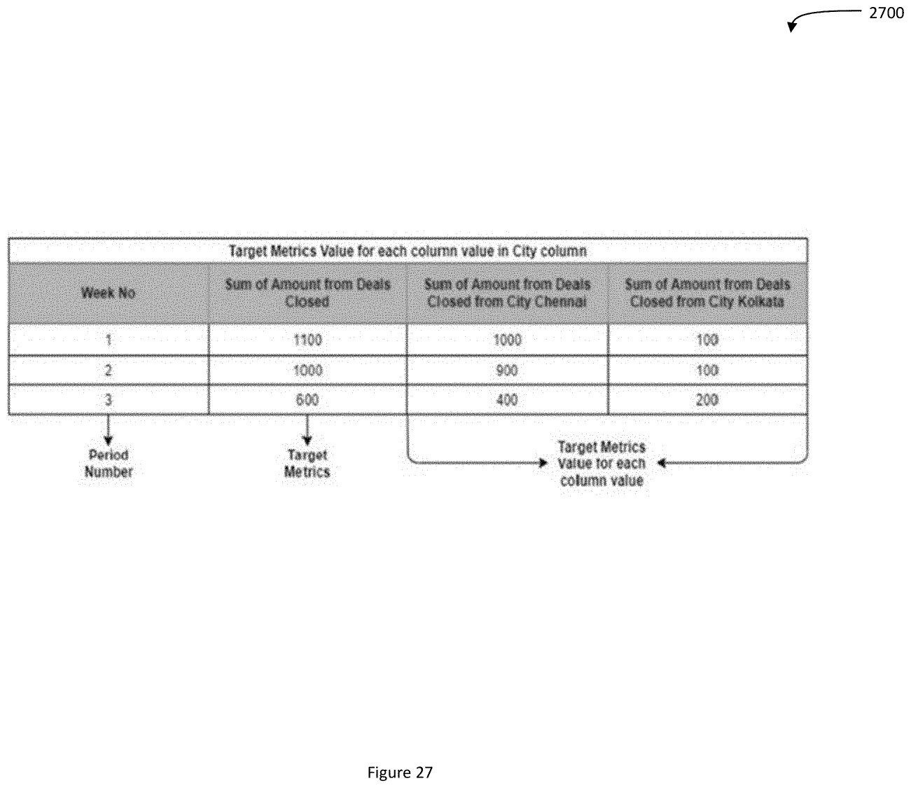

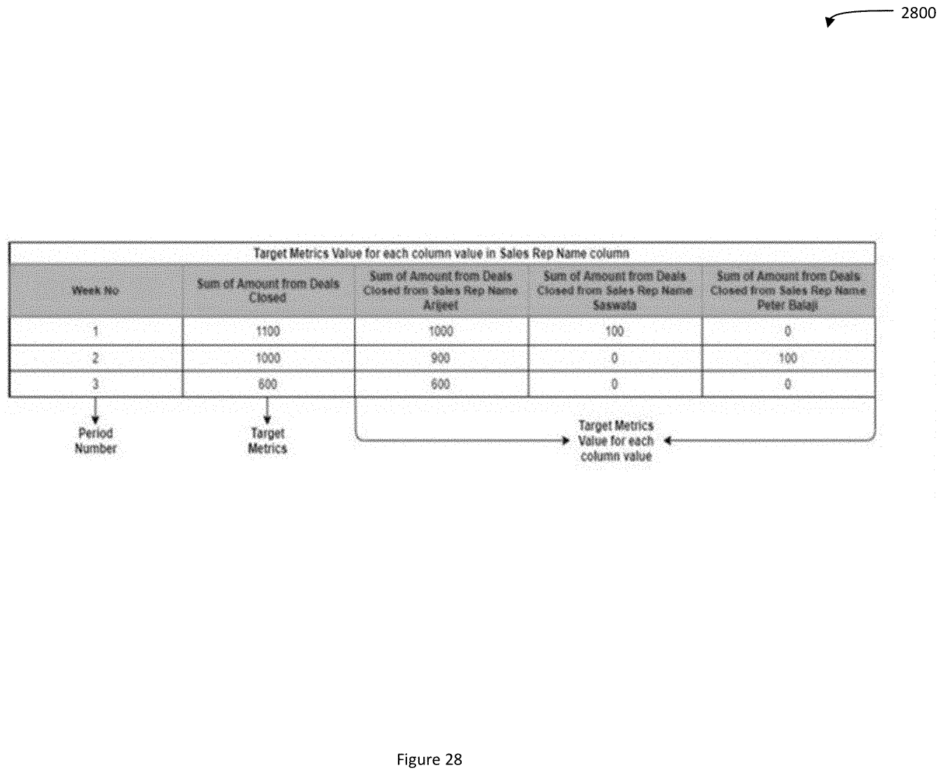

Step 1: The target metrics value is calculated and listed for each column value of the important categorical column with respect to the period number. Consider our data scenario; the target metrics value for all the column values Arijeet, Saswata, and Peter are calculated and listed for the three periods. A pictorial representation of target metrics value for each column value in city column is shown in FIG. 27 and a pictorial representation of target metrics value for each column value in sales rep name column is shown in FIG. 28.

Step 2: The next step involves calculating the Spearman's Correlation value between the target metrics and the target metrics value for each column. Considering our data scenario, Spearman Correlation between Sum of Amount from Deals Closed and Sum of Amount from Deals Closed by Sales Rep Name Arijeet=SpearmanCorr([1100, 1000, 600], [1000, 900, 600]).

Step 3: Important Categorical Column Values are then selected based on the Spearman Correlation Value, and the categorical column values with a higher score are considered ahead in the order of importance.

The important categorical/grouping columns and column values are stored after completion of the training.

The output engine 1720 is intended to represent an engine for storing the output of deep metrics discovery. In a specific implementation, the output includes 1) important supporting metrics (selected by ISM ranking engine 1714); 2) Supporting metrics meta information (produced by the meta enrichment engine 1716); and 3) Important categorical/grouping columns of primary table (produced by the important categorical columns discovery engine 1718).

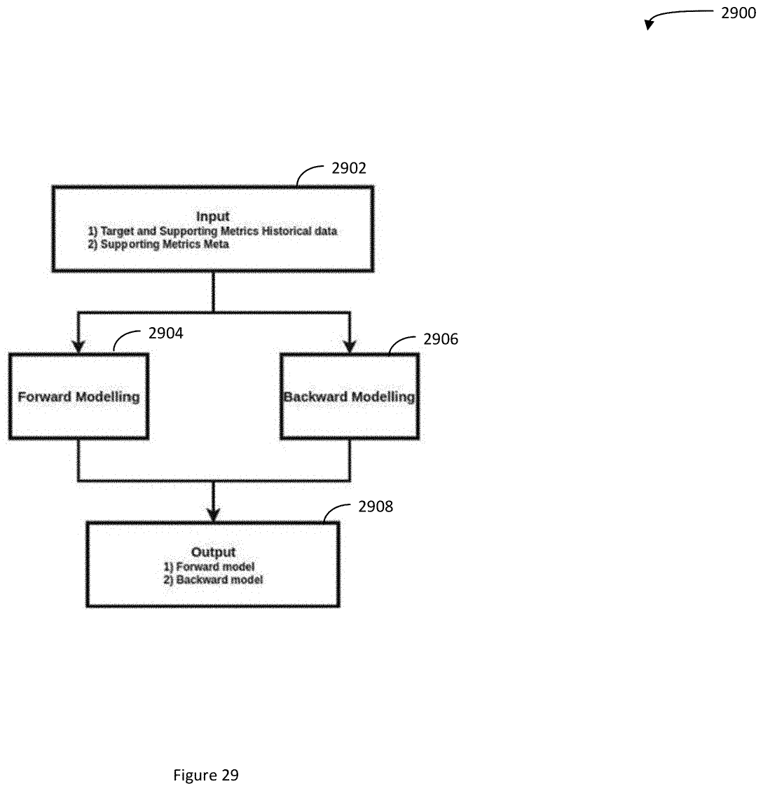

Referring once again to the example of FIG. 15, the TMSM association modelling engine 1506 is intended to represent an engine responsible for determining a relationship between target and supporting metrics. FIG. 29 illustrates a block diagram of an example of a TMSM association modelling engine, such as the TMSM association modelling engine 1506. FIG. 29 includes an input engine 2902, a forward modeling engine 2904, a backward modeling engine 2906, and an output engine 2908.

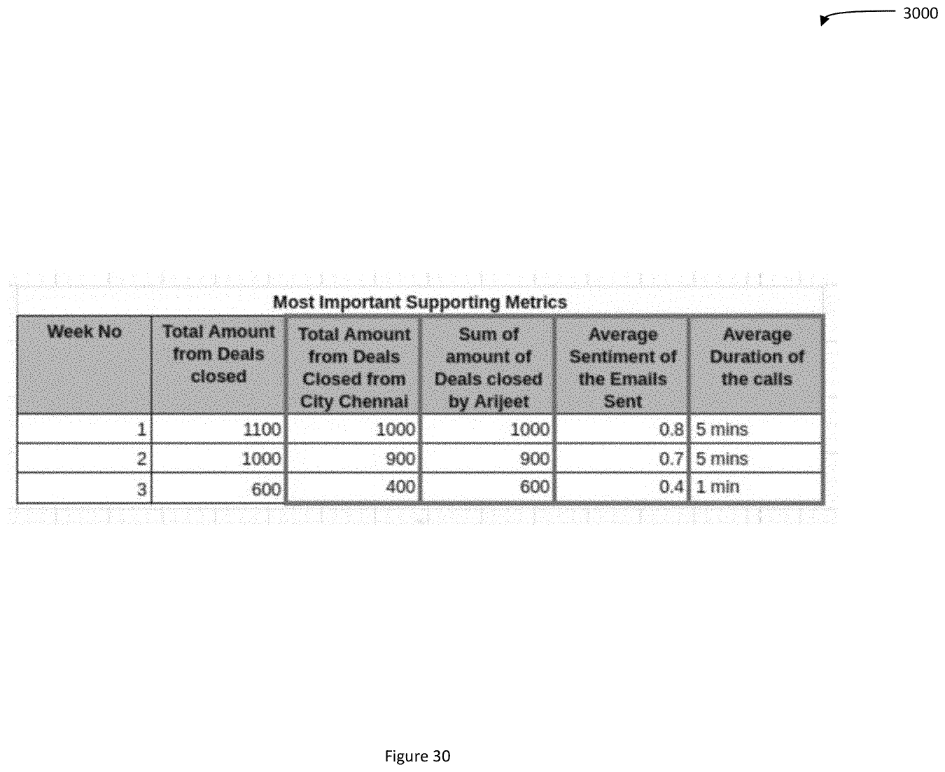

The input engine 2902 is intended to represent an engine that provides historical data for the supporting metrics and target metrics and supporting metrics meta information. Historical data for a metrics means the value of metrics over timeline of past periods, which is used for both supporting and target metrics. For our example case study, the historical data for important supporting metrics and target metrics over past timeline of periods is represented in FIG. 30. Here the first column is the timeline of period (i.e., the week number), the second column is the target metrics, and the rest of the columns are important supporting metrics. To train the algorithm we use the correlation coefficient and the range information of the supporting metrics from the supporting metrics meta information provided by a deep metrics discovery engine, such as the deep metrics discovery engine 1504.

The forward modeling engine 2904 is intended to represent and engine that determines a relation between the supporting metrics and target such that it can predict the target metrics given the values of the supporting metrics. In a specific implementation, this is achieved with the help of a constrained linear regression model fit with the historical data, where the supporting metrics are input variables and target metrics are the output variables. Regression basically finds an optimum equation which best maps the input variables to the target. Pursuant to our case study example, the forward modeling equation may look like Sum of Amount from Deals closed (Target)=(0.2*Total Amount from Deals Closed from City Chennai)+(0.8*Sum of amount of Deals closed by Arijeet)+(200*Average Sentiment of the Emails Sent)+(15*Average Duration of the calls)+60000. As we can figure out whether a supporting metrics positively or negatively contributes to the output from the correlation coefficients of the supporting metrics, we put a constraint on the coefficients (the number which multiplies the Supporting metrics) of the linear regression model. If a particular supporting metrics has a positive correlation with the target metrics, we do not let the coefficient of that variable in the linear regression equation go below zero. Similarly for the supporting metrics with negative correlation coefficient, we do not let the coefficient of the supporting metrics in the linear regression equation go above zero.

The backward modeling engine 2906 is intended to represent an engine that determines a relation between the supporting metrics and target such that it can predict the values of the supporting metrics given the value of the target metrics. In a specific implementation, this is achieved by fitting several linear regression models on our data, where each model takes the target metrics as input and predicts a supporting metric; if there are n number of supporting metrics, there will be n number of regression models. We name all these regression models, which map the target metrics to a particular supporting metrics, together as the backward model.

The output of the TMSM model association engine are the forward and backward models. The output engine 2908 stores them.

Referring once again to the example of FIG. 15, the datastore 1508 is intended to represent a datastore for 1) important supporting metrics, 2) supporting metrics meta, 3) Best grouping columns, and 4) Forward and backward models.

### Serving

In a specific implementation, a server system includes a strategy planner engine, a flaw finder engine, a predictor engine, and a prescriptor engine and answers questions with visual interaction though UI making use of the findings saved by the training module. We are now going to discuss the Strategy Planner, Flaw Finder, Predictor, and Prescriptor in detail.

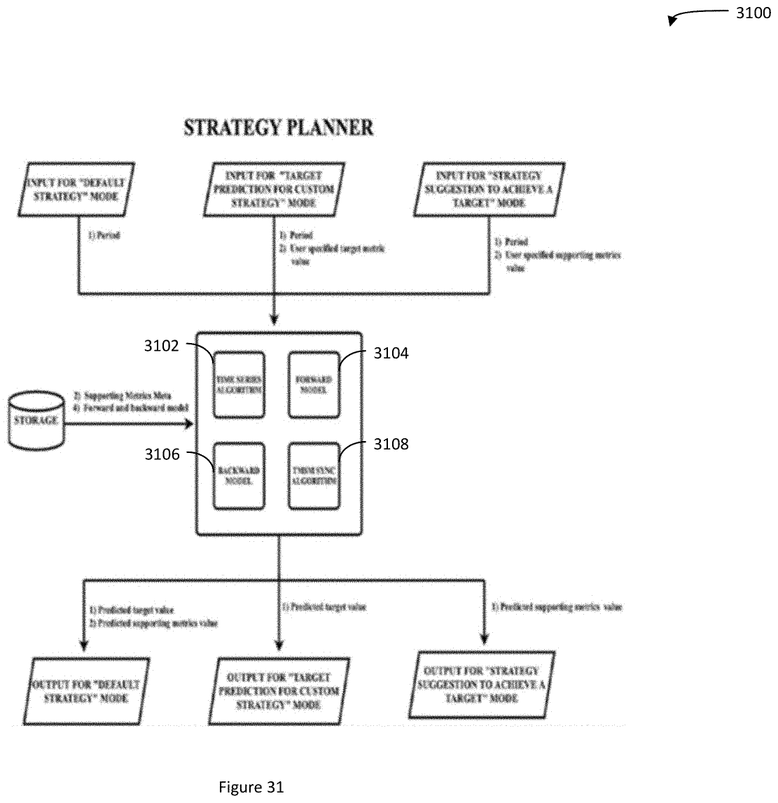

FIG. 31 shows the flow diagram 3100 of a strategy planner. Inputs to the strategy planner include input for “default strategy” mode, input for “target prediction for custom strategy” mode, and input for “strategy suggestion to achieve a target” mode. These strategy inputs were described above with reference to the 7 questions. Now we are going to describe the technical design of the strategy planner. The strategy inputs are provided to a system comprising four engines: a timeseries engine 3102, a forward model datastore 3104, a backward model datastore 3106, and a TMSM sync engine 3108.

The timeseries engine 3102 is intended to represent an engine that utilizes a timeseries predictor engine, which may incorporate a univariate timeseries predictor algorithm. The input to the univariate timeseries predictor is historical data (timeseries), prediction start timestamp, and end timestamp. In a specific implementation, the timeseries engine 3102 predicts the value for the future timestamps which falls between the start and end timestamps provided as an input to the engine.

The forward model datastore 3104 is intended to represent a forward model saved during training. With the help of this model, we can predict the value of the target metrics given the values of the supporting metrics. For example, the supporting metrics value for Zykler Pvt Ltd is 1) Total Amount from Deals Closed from City Chennai, $12,000; 2) Sum of amount of Deals closed by Arijeet, $12,000; 3) Average Sentiment of the Emails Sent, 0.8; and 4) Average Duration of the calls, 10 minutes. The forward model will do the below mentioned steps to find the predicted value of the target metrics for the given supporting metrics value.

Step 1: Forward model and supporting metrics meta is fetched from storage.

Step 2: The given supporting metrics values are scaled using standardization technique, as during training, model was trained on standardized values. For our example use case, after scaling, the supporting metrics, it is going to look like 1) Total Amount from Deals Closed from City Chennai, 0.9; 2) Sum of amount of Deals closed by Arijeet, 0.6; 3) Average Sentiment of the Emails Sent, 0.2; 4) Average Duration of the calls, 0.6.

Step 3: The feature values are passed to the forward model to predict the value of the target metrics. For our example, let us assume the equation of the forward model is: Target=(20000*Total Amount from Deals Closed from City Chennai)+(30000*Sum of amount of Deals closed by Arijeet)+(15000*Average Sentiment of the Emails Sent)+(25000*Average Duration of the calls)+60000. The given supporting metrics values are fed into this equation to calculate the target: Target=(20000*0.9)+(30000*0.6)+(15000*0.2)+(25000*0.6)+6000=60000.

Step 4: This predicted target ($60,000) is returned to the user.

The backward model datastore 3106 is intended to represent a backward model saved during training. With the help of this model, we can predict the value of the supporting metrics given the value of the target metrics. For example, the user has set the target metrics value for Zykler Pvt Ltd is: Total Amount from Deals closed, $80,000. The backward model will do the below mentioned steps to find the predicted value of the supporting metrics for the given target metrics value.

Step 1: Backward model and supporting metrics meta is fetched from storage.

Step 2: If we recap the training of the backward model, backward model contains ‘n’ (number of supporting metrics. In our example, n=4) linear regression models which were trained with input as target metrics and output as one of the supporting metrics. For each supporting metrics one linear regression model was generated. So here, we will take each model and feed the target metrics value as input which will return the corresponding supporting metric value. For our study example, the equation of the backward model for the supporting metric “Total Amount from Deals Closed from City Chennai” is like Total Amount from Deals Closed from City Chennai=(0.02*Total Amount from Deals closed)+2000. The given target metrics value is fed into this equation to calculate the corresponding supporting metric value: Total Amount from Deals Closed from City Chennai=(0.02*80000)+2000=18,000. Similarly, the predicted value is calculated for other supporting metrics.

Step 3: Error of the supporting metrics values are adjusted using TMSM sync engine 3208.

Step 4: This predicted supporting metrics values are returned to the user.

The forward model predicts the target metrics from the supporting metrics using constraint regression model and the backward model predicts the supporting metrics value from the target metrics using separate regression models. But here the problem is after calculating the supporting metrics value from the backward model, if we feed those supporting metrics values to the forward model, then the returned predicted target metric value may not be equal to the actual target metric value (which we fed as input to the backward model). For example, let say we input $80,000 to the backward model, which will return the corresponding support metrics values: 1) Total Amount from Deals Closed from City Chennai, 18000; 2) Sum of amount of Deals closed by Arijeet, 30000; 3) Average Sentiment of the Emails Sent, 0.5; 4) Average Duration of the calls, 20. If we input these supporting metric values to the forward model then it will return the target metrics value as $83,000. So here we clearly see that the target which we have given as input to backward model ($80,000) is not same as the value we got from forward model ($83,000). Here the error is $3000, so we need to eliminate this error by adjusting the supporting metrics value to make the forward and the backward model in sync. This will be achieved using TMSM sync engine.

The TMSM sync engine 3108 is intended to represent an engine that adjusts a supporting metrics value to put the forward and the backward model in sync. Let follow this naming convention: actual target is the value given as input to backward model ($80,000). Predicted target is the value which we got as a result from forward model ($83,000). Supporting metric predicted values is the value we got as a result from backward model (Total Amount from Deals Closed from City Chennai—18000, . . . ). Now, the steps.

Step 1: Calculate predicted target using forward model. Input is supporting metric predicted values and output is predicted target.

Step 2: Calculate the error, e.g., the difference between actual and predicted target. Error=actual target−predicted target.

Step 3: Find the error contribution to each supporting metrics. This is calculated by the feature importance score (calculated during training) of the supporting metrics. Error contribution for supporting metric 51=feature importance score of 51/(sum of feature importance score of all supporting metrics). Suppose the feature importance score of each supporting metric is: 1) Total Amount from Deals Closed from City Chennai, 0.9; 2) Sum of Amount of Deals closed by Arijeet, 0.85; 3) Average Sentiment of the Emails Sent, 0.8; 4) Average Duration of the calls, 0.95. The error contribution of the supporting metric “Total Amount from Deals Closed from City Chennai” is: Error contribution=feature importance score of “Total Amount from Deals Closed from City Chennai”/sum of all feature importance score=0.9/3.5=0.257. This means that the predicted value of supporting metric “Total Amount from Deals Closed from City Chennai” is adjusted such that it should decrease the 25.7% of the error.

Step 4: Adjust the supporting metric predicted values based on its error contribution. For example, the adjusted value for “Total Amount from Deals Closed from City Chennai” is: 1) Subtract its contributed error from the predicted target, i.e. temp target=predicted target−(error contribution*error)=83000−(0.257*3000)=82229 and 2) new supporting metric value=(temp target−sum of all other supporting metric's (coefficients*supporting metric value)−intercept)/co efficient of “Total Amount from Deals Closed from City Chennai”. Similarly calculate for other supporting metrics.

Step 5: Return the new supporting metric values.

Now we will discuss the flow for the three strategies. Default strategy mode is responsible for showing the likely strategy user is going to follow in the user-given period (e.g., week, month, etc.) and shows the value of target metrics that could be achieved with that strategy. With respect to our data scenario, default strategy would show the strategy to achieve a $40,000 target in the week. Now we are going to see how this mode works.

Step 1: Input for the default strategy mode will be 1) period: start period and end period and 2) mode: initial.

Step 2: Last 1 year data is queried from the database for target metrics and user given time period is given as input to the timeseries engine to predict the target metric value. (In our example it is $40,000.) Input for timeseries engine: period, data. Output from timeseries engine: predicted value of target metrics for the given period.

Step 3: Then using the backward model, we will find the strategy to achieve that predicted target ($40,000). Input for backward model: target metric value. Output from backward model: Expected Supporting metrics values to achieve that target metric value.

Step 4: TMSM sync engine is used to adjust the supporting metrics values so that it stay synced with the forward model. Input is expected supporting metrics values, feature importance score dictionary, and forward model. Output is Adjusted Supporting metrics values.

Step 5: Finally, the predicted target metric value and the strategy to achieve that is returned to the user.

Target prediction for custom strategy mode will enable the user to create custom strategies by setting values supporting metrics to see how it affects the target metrics. With respect to our data scenario, the user changed the supporting metrics “Average sentiment of email” value from 0.6 to 0.8, then the custom strategy mode shows the user the value of target metrics he can achieve with that strategy. In this case the user can achieve $60,000 with that strategy. Note: The value of target metrics was changed from $50,000 to $60,000 by the framework upon providing the custom strategy. Now we are going to see how this mode works.

Step 1: Input for custom strategy mode is 1) mode: forward; 2) period; 3) supporting metrics value.

Step 2: The supporting metrics value is passed to forward model which will return the predicted target. Input for forward model: Supporting metrics value. Output from forward model: Predicted target value for given supporting metrics value.

Step 3: Finally, the predicted target metric value is returned to the user.

Strategy Suggestion to achieve a target mode will enable the user to set a target for the target metrics and get the suggested strategy for achieving that target. A strategy can be characterized as values of the supporting metrics suggested by the engine, which, if the user achieves, would help to achieve that target. With respect to our data scenario, the user changed the target metrics value from $60,000 to $80,000, then the “strategy suggestion to achieve a target” mode shows the user the strategy: 1) Total Amount from Deals Closed from City Chennai, $18,000; 2) Sum of amount of Deals closed by Arijeet, $14,000; 3) Average Sentiment of the Emails Sent, 0.95; 4) Average Duration of the calls, 14 minutes. Now we are going to see how this mode works.

Step 1: Input for strategy suggestion to achieve a target mode is 1) mode: backward; 2) period; 3) target metrics value.

Step 2: The target metrics value is passed to the backward model which will return the expected supporting metrics value to achieve that given target. Input for backward model: Target metrics value. Output from backward model: Predicted supporting metrics value for given target metrics value.

Step 3: TMSM sync engine is used to adjust the supporting metrics values so that it stays synced with the forward model. Input is expected supporting metrics values, feature importance score dictionary, and forward model. Output is adjusted supporting metrics values.

Step 4: Finally, the adjusted supporting metrics value is returned to the user.

Flaw finder is a descriptive analytics component which is capable of detecting what went wrong for a past time period. It is based on an anomaly analyzer engine. The anomaly analyzer engine will detect if any anomaly has happened in the target metric for the user given time period in the past using target metric anomaly detector. So, if an anomaly happens, then the anomaly reason finder engine will find the major contributing reasons for that anomaly with its impact on the target metric. With respect to our data scenario, the user needs to know whether anomaly has happened in the target metrics on the last month i.e. (January 1 to January 31). So here, flaw finder detected the anomaly in the target metrics i.e., Actual value of total amount of deals closed this month is $10,000 but its expected value is $30,000. Based on that past data analysis, the target metric anomaly detector marked this difference $20,000 (expected—actual) as an anomaly. Then the anomaly reason finder engine finds the major contributing reasons for that anomaly i.e., Why total amount of deals closed this month is decreased by $20,000. It shows the reasons like: Average Sentiment of the Emails Sent with closing date on January 2 decreased by 80%; Actual value: 0.25; Expected value: 0.8; Target impact: $4000.

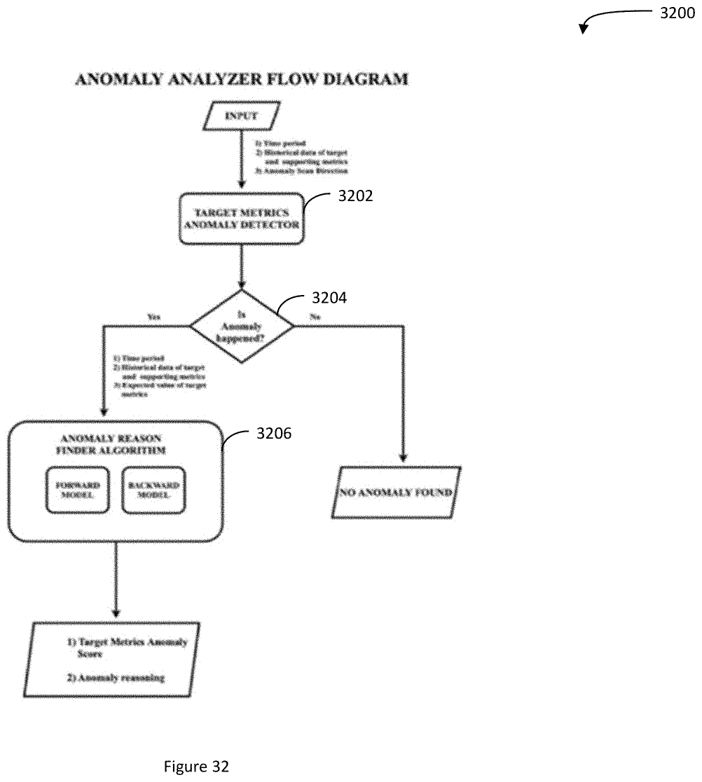

FIG. 32 depicts an example of an anomaly analyzer flow diagram 3200. Input includes Analysis Time period, Historical data for target and supporting metrics, and Anomaly Scan Direction. The analysis time period is a time period in the past for which we need to check if anomaly has happened or not. Considering our data scenario, the Analysis Time Period is 01/01/2018 to 31/01/2018.

Historical data for the target and supporting metrics contains the values for all these metrics in the past. With the help of this data trends are analyzed and anomalies are marked in Table 8. The first column is the period number (timestamp), second column is the target metrics and rest of the columns are supporting metrics.

TABLE 8
Marked Anomalies

| | Total | Total Amount of | Sum of Amount | Average | Average |
|---|---|---|---|---|---|
| | Amount of | Deals Closed from | Closed by | sentiment of | duration |
| Period | Deals Closed | City Chennai | Arjeeth | emails sent | of calls |
| 20 Jan. 2017 | 1000 | 700 | 100 | 0.6 | 2 |
| 21 Jan. 2017 | 1200 | 300 | 400 | 0.8 | 4 |
| . . . | . . . | . . . | . . . | . . . | . . . |
| 1 Jan. 2018 | 500 | 500 | 500 | 0 | 0 |
| . . . | . . . | . . . | . . . | . . . | . . . |
| 19 Jan. 2018 | 400 | 400 | 400 | 0.85 | 7.5 |

Considering our data scenario, the objective of the target metrics is positive (i.e., increase of target metrics in favor of the user). Accordingly, the target metrics anomaly detector engine 3202 assigns the anomaly scan direction as “negative” so that the anomaly analyzer engine can scan for the anomalies in the negative direction (i.e., when the actual value is lesser than the expected value of the target metrics Total amount from Deals closed (Revenue)). In a specific implementation, the target metrics anomaly detector engine 3202 makes use of a univariate timeseries anomaly detection engine. Univariate timeseries anomaly detector input includes Historical data for target metrics and Time period in past. Output includes anomaly score. The steps are:

Step 1: The timeseries anomaly detector engine uses timeseries decomposition technique, ACF, and moving average to approximate the expected value for each timestamp in the historical data.

Step 2: Then the error which is the difference of actual value and expected value is passed into the anomaly score finder engine to calculate the score. This score tells us how the actual value of the target metrics has deviated from its expected value.

Step 3: Now the calculated score for a time period in past is aggregated score of all those timestamps which appeared in that time period.

Step 4: Finally, the anomaly score, predicted value for the given time period is returned to the user.

Now we are going to detect if any anomaly has happened in the target metrics based on given anomaly scan direction. Input includes 1) Historical data for target; 2) Time period—Time period in past; and 3) Anomaly Scan Direction. Output includes whether anomaly happened (True False) and Anomaly score, which is only applicable if “anomaly happened” is True. The steps are:

Step 1: The historical data for target metrics and time period is given as input to univariate timeseries anomaly detector engine which will returns the anomaly score and expected value for that time period. Considering our data scenario, Expected value: $30,000; Actual value: $10,000; and Anomaly score: 50.

Step 2: The anomaly scan direction is retrieved from the storage. With respect to our example, the anomaly scan direction is positive.

Step 3: Using actual and expected values of the target metrics, the actual anomaly type is calculated based on the pitch objective for the given time period. With respect to our example, the anomaly has happened in the negative direction as the actual value ($10,000) of the target metrics for the analysis time period is lesser than the expected value ($30,000).

Step 4: If the direction of the anomaly is the same as anomaly scan direction then ZAAF will call the anomaly reason finder engine, described previously, to find the major contributing reasons for that anomaly. With respect to our data scenario, anomaly scan direction and actual anomaly type are negative. So, this is marked as an anomaly.

Step 5: If above condition step 4 is not satisfied, then it will return Is anomaly happened as false and no anomaly reasoning is generated for obvious reasons.

The anomaly reason finder engine 3206 is responsible for finding the reasons for the anomaly in target metrics caused in the previous block. We store the list of reasons found by the engine in a table. Each reason has 5 attributes: Supporting Metrics Name, Start Time, End Time, Effect on target, and Severity Score. The reasons found by the anomaly reason finder engine 3206 are stored in this table and then we provide users the top reasons by sorting it out based on the Severity score.

TABLE 9
Anomaly Reasoning

| | | | Effect on | Severity |
|---|---|---|---|---|
| Supporting Metrics Name | Start Period | End Period | Target | Score |
| Total Amount from Deals Closed from City | 5 Jan. 2018 | 10 Jan. 2018 | −3900 | 0.85 |
| Chennai | | | | |
| Sum of amount of Deals closed by Arijeet | 15 Jan. 2018 | 15 Jan. 2018 | −500 | 0.8 |
| Average Sentiment of the Emails Sent | 2 Jan. 2018 | 2 Jan. 2018 | −4000 | 0.99 |
| Average Duration of the calls | 20 Jan. 2018 | 25 Jan. 2018 | −500 | 0.75 |
| Average Sentiment of the Emails Sent | 30 Jan. 2018 | 31 Jan. 2018 | −300 | 0.66 |

Now we are going to see how the reasons are found out and added in the above table 9.

Step 1: We split it into time periods in sub periods and analyze each sub period for reasoning separately. In our data scenario, the sub periods will be (01/01/2018, 1/01/2018), (01/01/2018, 02/01/2018), (01/01/2018, 03/01/2018), . . . , (01/01/2018, 31/01/2018), . . . , (02/01/2018, 03/01/2018), . . . . Similarly sub periods is formed by taking all sequential combination of periods between 01/01/2018 and 31/01/2018.

Step 2: For each sub period we check whether there is an anomaly in the target metrics in the anomaly scan direction. If an anomaly is in target metrics for that sub period, we execute rest of the steps to find the reasoning for the anomaly for that sub period. In our data scenario, let's take the sub period 05/01/2018 to 10/01/2018. For this, the actual value of the target metrics is $1100, and its expected value is $15,000. Here the anomaly type is in the anomaly scan direction (i.e., both are negative), so step 3 is executed which checks what are the major reason for this $13,900 difference between actual and expected value of the target metrics between the time period 05/01/2018 and 10/01/2018.

Step 3: If anomaly is there in the target metrics of that sub period in the Anomaly Scan Direction, we try to see which supporting metrics values are causing that anomaly in that sub period. To do that we follow steps 3.1. and 3.2.

Step 3.1: For the sub period, we take the expected value of target metrics and feed it to the backward model, described previously, which provides the expected value of all the supporting metrics with which we can achieve the target for the sub period. With respect to our data scenario, the expected value of the target metrics for the sub period 05/01/2018 to 10/01/2018 is $15000. So, we will feed this as an input to the backward model which in turn returns the expected of all the supporting metrics between 05/01/2018 to 10/01/2018: 1) Total Amount from Deals Closed between from City Chennai, $5000; 2) Sum of Amount of Deals closed by Arijeet, $1000; 3) Average Sentiment of the Emails Sent, 0.6; 4) Average Duration of the calls, 3 minutes.

Step 3.2: For that sub period, if the actual values of the supporting metrics were equal to expected values suggested by the backward models, we would not have gotten any anomaly in the target metrics. But as there is an anomaly in the target metrics for that sub period, we can assume that the actual values of the supporting metrics were not as expected. That is why we should try to find out which supporting metrics caused the anomaly for that sub period. For that we try to isolate each supporting metric at a time and test its contribution to the anomaly of the target metrics for that sub period in the Anomaly Scan Direction.

To do that, we plug in the actual value of the supporting metric in focus and predicted values of the other supporting metrics (derived in Step 3.1) to the forward model, described previously. This isolated target prediction is then compared with the expected value determined by the timeseries model of the target metrics for this sub period. If the direction of deviation of the isolated target prediction from the target metrics expected value is same as anomaly scan direction, we can conclude the supporting metrics in focus, is contributing to the anomaly for that sub period under study. Hence, we make an entry in the anomaly reason table with severity score and effect on target.

With respect to our data scenario, now we need to find which supporting metrics are the cause for the $13,900 difference between actual and expected value of the target metrics for the time period 5/1/2018 and 10/1/2108. For this we will iterate all the supporting metrics one by one. To elaborate that, let us say we pick up the supporting metric “Total Amount from Deals Closed from City Chennai” to test whether it contributed to the anomaly in the target metrics for the period 5/1/2018 to 10/1/2018. For this we will input the actual value of this supporting metrics and the expected value for other supporting metrics to the forward model i.e. Isolated Prediction Total Amount from Deals Closed from City Chennai=(20000*Actual Total Amount from Deals Closed from City Chennai)+(30000*Expected Sum of amount of Deals closed by Arijeet)+(15000*Expected Average Sentiment of the Emails Sent)+(25000*Expected Average Duration of the calls)+6000.

After we apply standardization to all the supporting metrics values and feed that values into this equation, we will get $11,100 as the isolated prediction. So, the direction of deviation between expected target metrics value for this sub period and isolated target prediction is the same as the anomaly scan direction. From this we can conclude that the supporting metric “Total Amount from Deals Closed between from City Chennai” is one of the causes for anomaly between the sub period 05/01/2018 to 10/01/2018. Calculate the target impact and severity score and then add this supporting metrics as shown in Table 10. Target impact is calculated by Target impact=Isolated Prediction−Expected target metrics value for this sub period (January 5 to January 10)=11100-15000=−3900.

TABLE 10
Supporting Metrics Name Start period End period Effect on target Severity Score

| | | | Effect on | Severity |
|---|---|---|---|---|
| Supporting Metrics Name | Start Period | End Period | Target | Score |
| Total Amount from Deals Closed from City | 5 Jan. 2018 | 10 Jan. 2018 | −3900 | 0.85 |
| Chennai | | | | |

The same step is repeated for all supporting metrics. So, if that supporting metrics is the cause of that anomaly, then we will include that supporting metric in the above Table 10.

Step 4: After running all these steps the reason table contains a list of anomaly reasons with a score. We finally show the top reasons for the anomaly by ranking the reasons with respect to the score. The output of the flaw finder is target metrics anomaly score and anomaly reasoning.

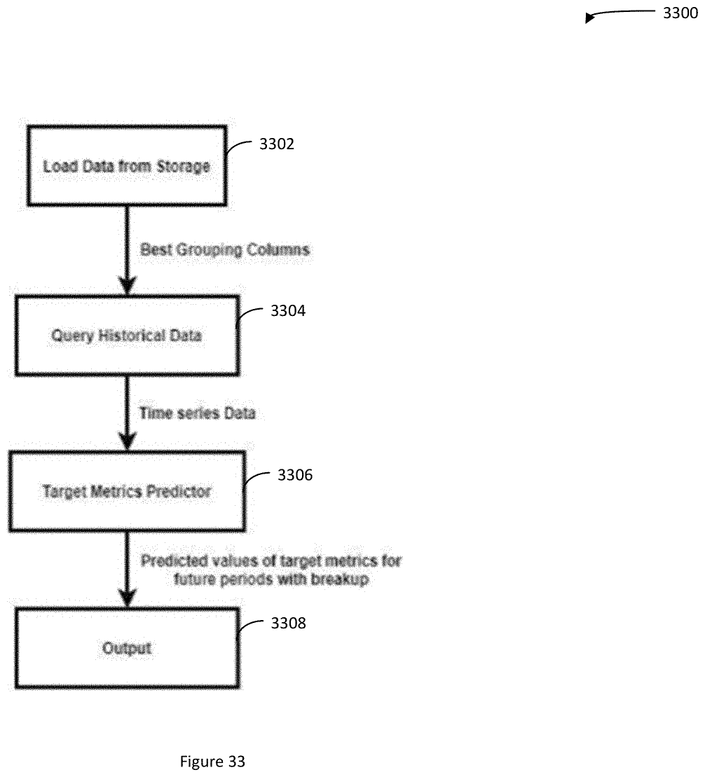

FIG. 33 is a flowchart 3300 of an example of a predictor. The predictor is responsible for predicting the target metrics value for a future period. It also shows the breakup of that prediction with respect to the most important categorical column. For example, in our case study data scenario, in the Deals table, assume that column Sales Rep Name is identified as the most important categorical column and the important values in that column are Arijeet, Saswata, and Peter sorted in order of their importance with respect to the target metrics. The predictor predicts the future values of target metrics (Sum of Amount from Deals closed) and provides a breakup of that prediction i.e., Sum of Amount from Deals closed for Arijeet, Saswata, and Peter.

At module 3302, the most important categorical column and column values which were identified and are retrieved from the storage; they are going to be used for giving a breakup of the prediction of the target metrics. With respect to our example data scenario, the most important categorical column saved during the training was Sales Rep Name and the most important values in that column were Arijeet, Saswata, and Peter sorted in terms of importance.

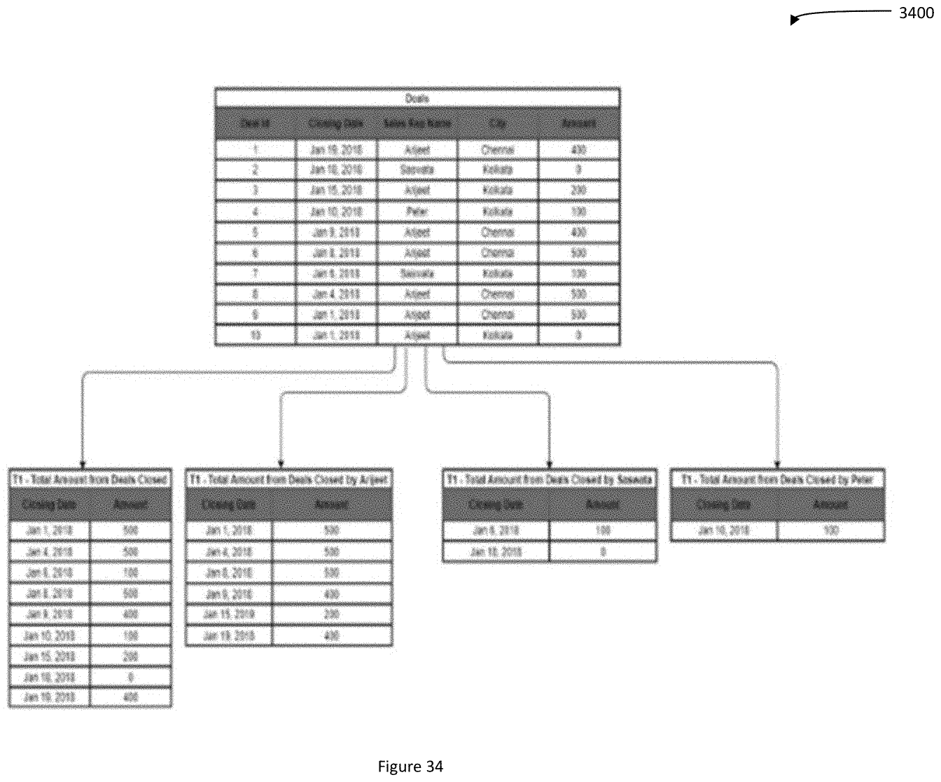

At module 3304, the historical data is fetched for the target metrics. Also, the historical data of the target metrics for each category of the most important categorical column is retrieved. This historical data retrieved here is used by the timeseries predictor to predict the target metrics value in the future. This historical data is also called timeseries data. Let us assume our case study data scenario, in which the column Sales Rep Name is the most important categorical column of the primary table and the values Arijeet, Saswata, and Peter are the most important values in that column sorted in terms of their importance with respect to the target metrics. The historical data (e.g., timeseries) for target metrics (Total Amount from Deals closed) is retrieved first. Also, the historical data for the target metrics for each important groups (Total Amount from Deals closed by Arijeet, Total Amount from Deals closed by Saswata and Total Amount from Deals closed by Peter) are retrieved. For better understanding, FIG. 34 shows the pictorial representation of historical data for target metrics.

At module 3306, future values of the target metrics are predicted and a breakup for that with respect to the most important categorical column in the primary table is provided. To do that, we pass each of the timeseries (target metrics timeseries and timeseries of the target metrics for each group) framed in the Query Historical data module to a timeseries predictor engine. The engine makes predictions for each of those timeseries for a period in the future.

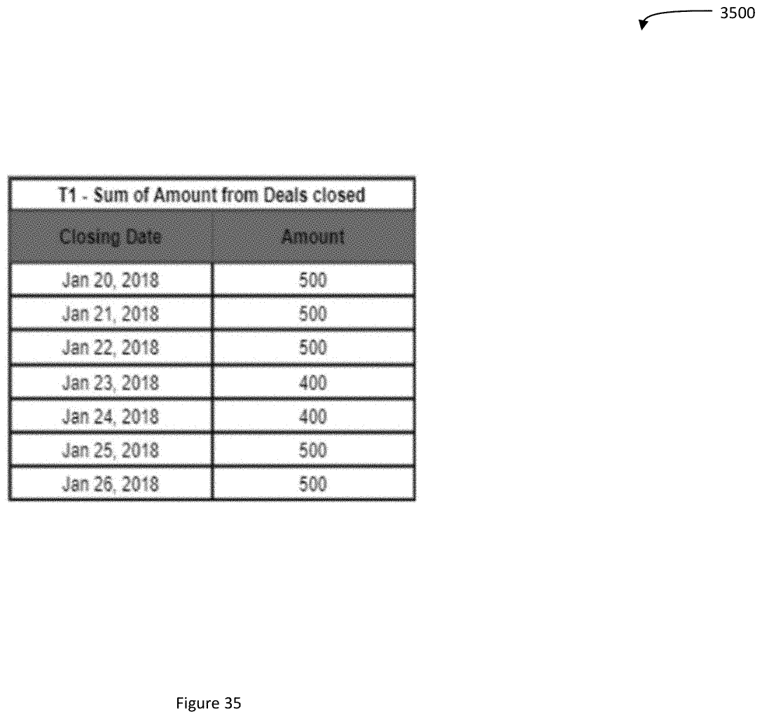

In a specific implementation, the timeseries predictor is a univariate timeseries predictor. A univariate timeseries predictor is built upon a timeseries decomposition technique. The input to the univariate timeseries predictor is historical data (timeseries), the prediction start timestamp, and end timestamp. The univariate timeseries predictor predicts the value for the future timestamps which falls between the start and end timestamps provided as an input to the engine. The engine internally uses timeseries decomposition technique, ACF, and moving average to make the prediction. With respect to our case study, there are four timeseries as illustrated previously. For each timeseries, univariate timeseries predictor is invoked. For demonstration let us consider the first timeseries (T1−Sum of Amount from Deals). We pass this data to the engine along with Jan. 20, 2018, and Jan. 25, 2018, as start and end period respectively. The output of the engine is shown in FIG. 35. Then finally the predicted values for the future time stamps are clubbed together to provide the final prediction for the whole period between the start and the end timestamps provided as an input. For the above example, the clubbed value of the T1−Sum of Amount from Deals closed for the week starting from January 20 and ending on January 26 is $3300 (500+500+500+400+400+500+500). The same process is repeated for each timeseries retrieved in the section “Query Historical data”.

At module 3308, for different periods in the future (e.g., next week, next month, next quarter) the predictions are provided as output with break up using the steps mentioned above.

The prescriptor is responsible for helping an agent achieve expected values for target metrics. For example, the predictor can show suggestions to a user that help the user achieve expected targets. Also, if some unexpected anomaly happened so a user is unable to achieve an expected target, the prescriptor will automatically adjust a future expected value of the target metric such that the user can compensate for the previous loss.

With respect to our data scenario, suppose the user needs the prescription for this week (Jan. 4, 2021-Jan. 10, 2021) in daily resolution. i.e., User needs the daily expected value from the system to achieve their weekly expected value of the target metrics. So, the weekly expected value is $50000. The Prescriptor will show the daily prediction value (i.e., $6000 on Jan. 4, 2021, $8500 on Jan. 5, 2021, . . . , $12500 on Jan. 10, 2021) inside the expected mode of prescriptor component. Now we will see how it works when setting short-term goals to achieve a long-term expected target.

Input is period type, e.g., this week (Jan. 4, 2021-Jan. 10, 2021) and resolution is daily. Output is expected value for this week (Jan. 4, 2021, to Jan. 10, 2021): $50,000 and expected value for a user-given resolution. (Here, the user has given the resolution as “daily.”) This is shown in Table 11:

| Time period | Expected value |
|---|---|
| Jan. 4, 2021 | $6000 |
| Jan. 5, 2021 | $8500 |
| Jan. 6, 2021 | $4000 |
| Jan. 7, 2021 | $3000 |
| Jan. 8, 2021 | $6000 |
| Jan. 9, 2021 | $10000 |
| Jan. 10, 2021 | $12500 |

Step 1: We will use a univariate time series predictor to get the prediction values in the lower resolution. We have considered lower resolution as day. Input for time-series prediction is 1) Historical data queried from the database; 2) Start time period: Jan. 4, 2021; 3) End time period: Jan. 10, 2021. Output for time-series prediction in lower resolution is daily prediction values from Jan. 4, 2021, to Jan. 10, 2021.

Step 2: Aggregate the prediction values from Jan. 4, 2021, to Jan. 10, 2021, based on target aggregate. Here target aggregation is sum. So, we sum up all the prediction values from Jan. 4, 2021, to Jan. 10, 2021. The resultant value ($50,000) will become the expected value for this week (Jan. 4, 2021, to Jan. 10, 2021).

Step 3: Similarly aggregate the expected values based on user resolution. In this example, user resolution and univariate timeseries predictor lower resolution are the same (daily). So, we can directly mark the prediction values as output for the expected value for the user given resolution.

Step 4: The result from step 2 (this week's expected value) and step 3 (prediction values based on user-given resolution) are given as output for the expected mode of the prescriptor.

Now if the user moves the cursor over the prediction data point, then the system will suggest the best strategy to achieve the expected target. This flow is the same as the strategy suggestion to achieve a target mode described previously. The input for backward model is 1) mode: backward; 2) time period; 3) target metrics value: user selected prediction data point value. Output is contributing factors with its expected value.

If the excepted value suggested by the prescriptor's prediction mode does not match with the actual value on past time periods, the prescriptor can show the major contributing reasons for that discrepancy. Here, we will use the anomaly reason finder, described previously, to find the root cause for the difference between actual and expected value of the target metrics. Input to the anomaly reason finder includes time period, expected value of target metrics, and actual value of target metrics. Output includes major contributing supporting metrics that are the root cause for the difference between actual and expected value.

If a user is not able to achieve an expected target, the prescriptor will adjust future expected values to compensate for the previous loss. This adjusted value can be referred to as boosting value. Now we will see how to calculate this boosting value. In our running example, a user is unable to achieve an expected target on Jan. 4, 2021 (expected, $6000; actual, $2000). So, to compensate for this loss (−$4000), the prescriptor boosts expected values on future days, which is shown inside the boosting tab. Now we will see how this boosting value is calculated.

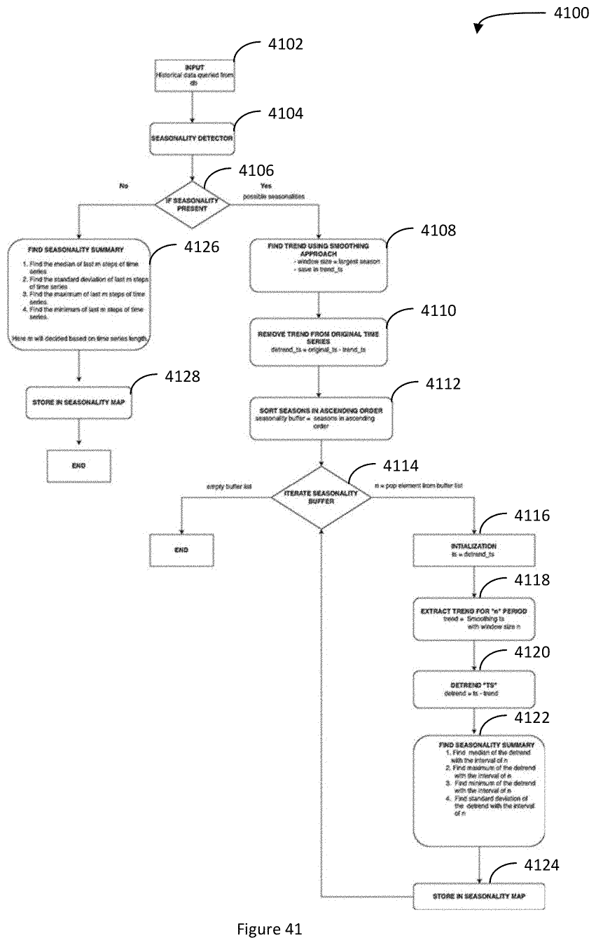

FIG. 41 is a flowchart 4100 of an example of a timeseries pattern analyzer. The flowchart starts at module 4102 with querying for historical data and continues to module 4104 where a time series pattern analyzer, such as a univariate time series pattern analyzer, of a seasonality detector fetches the time series pattern exiting in the past data. Input includes historical time series data, an example of which is shown in Table 12.

| Time Period | Target (Sum of Revenue) |
|---|---|
| 21 Aug. 2020 | 1300 |
| . . . | . . . |
| 20 Sep. 2020 | 2000 |
| 21 Sep. 2020 | 2100 |
| 22 Sep. 2020 | 2500 |
| 23 Sep. 2020 | 3100 |
| 24 Sep. 2020 | 3300 |
| 25 Sep. 2020 | 3500 |
| 26 Sep. 2020 | 4100 |
| 27 Sep. 2020 | 4500 |
| 28 Sep. 2020 | 4200 |
| 29 Sep. 2020 | 4600 |
| 30 Sep. 2020 | 5200 |
| 1 Oct. 2020 | 5400 |
| 2 Oct. 2020 | 5600 |
| 3 Oct. 2020 | 6200 |
| 4 Oct. 2020 | 6600 |

Output includes a seasonality map with one or more of 1) average seasonality pattern; 2) minimum seasonality pattern; 3) maximum seasonality pattern; 4) variation seasonality pattern.

Step 1: At decision point 4106, the seasonality detector determines whether seasonality is present. Detect seasonality existing in the sequential data, enabling detection for how many periods the data pattern is repeating. In this example, the pattern is repeating for every 7, 31 days.

Step 2: If potential seasonality is detected (4106—Yes), flowchart 4100 continues to module 4108 where the seasonality detector finds the trend using smoothing approach with window size as the largest seasonality number. With respect to our training data, the largest window size is 14. For the date 21/09/2020, the trend will be calculated as follows: (Sum the values from 21/08/2020 to 20/09/2020)/31=(1300++2000)/31=600.

Step 3: At module 4110, trend is removed from original time series. In this example, we detrend value for 21/09/2020=2100-600=1500. Trend is also removed from all data points and the result stored in detrend series.

Step 4: At module 4112, seasonality summary for each season time periods is found. In this example, a seasonality buffer holds the seasonality summary in ascending order.

At decision point 4114, it is determined whether seasonality buffer. If the buffer is not empty (4114—Yes), the prescriptor iterates; an element is popped from the seasonality buffer (e.g., n=pop element from buffer). At this point, the buffer is not empty, but the flowchart 4100 loops back to decision point 4114, as described momentarily, and the buffer may not be empty when it does.

At module 4116, time series is initialized to detrend time series, detrend_ts; at module 4118, trend is extracted for “n” period (e.g., trend=smoothing ts with window size n); and at module 4120, we detrend timeseries (e.g., detrend=ts—trend). In this example, modules 4118 and 4120 play out as capturing seasonality summary for “7” period gap: at module 4118, trend_window_size_7=extract trend using window size as 7; at module 4120, detrend_window_size_7=detrend−trend_window_size_7. For example, after removing trend, our detrend_window_size_7 series is shown in the Table 13:

| | Target after removing trend |
|---|---|
| Time Period | with 7 period interval gap. |
| 21 Aug. 2020 | 200 |
| 20 Sep. 2020 | 100 |
| 21 Sep. 2020 | 100 |
| 22 Sep. 2020 | 200 |
| 23 Sep. 2020 | 500 |
| 24 Sep. 2020 | 400 |
| 25 Sep. 2020 | 300 |
| 26 Sep. 2020 | 600 |
| 27 Sep. 2020 | 700 |
| 28 Sep. 2020 | 100 |
| 29 Sep. 2020 | 200 |
| 30 Sep. 2020 | 500 |
| 1 Oct. 2020 | 400 |
| 2 Oct. 2020 | 300 |
| 3 Oct. 2020 | 600 |
| 4 Oct. 2020 | 700 |

Step 5: Fold the time series data frame with “7” period interval gap. This is shown in the Table 14:

| Period Range | period1 | period2 | period3 | period4 | period5 | period6 | period7 |
|---|---|---|---|---|---|---|---|
| 21 Aug. 2020 to 27 Aug. 2020 | 95 | . . . | . . . | . . . | . . . | . . . | . . . |
| . . . | . . . | . . . | . . . | . . . | . . . | . . . | . . . |
| 21 Sep. 2020 to 27 Sep. 2020 | 100 | 200 | 500 | 400 | 300 | 600 | 700 |
| 28 Sep. 2020 to 4 Oct. 2020 | 110 | 225 | 550 | 395 | 305 | 625 | 705 |

SUMMARY

| | | | | | | | |
|---|---|---|---|---|---|---|---|
| median | 100 | 200 | 500 | 400 | 300 | 600 | 700 |
| maximum | 110 | 220 | 560 | 440 | 325 | 600 | 705 |
| minimum | 95 | 198 | 465 | 360 | 290 | 580 | 695 |
| standard deviation | 5 | 10 | 30 | 35 | 25 | 10 | 8 |

The flowchart 4100 continues to module 4122 with finding median, maximum, minimum, standard deviation for each period and to module 4124 with storing seasonality map. In a specific implementation, the seasonality map includes key (period no.) and value (summary results). The summary results can include one or more of median, maximum, minimum, and standard deviation.

Step 6: The flowchart 4100 then returns to decision point 4114 to repeat step 4 and step 5 for any remaining periods. If at decision point 4114, the buffer is empty, the flowchart 4100 ends.

Referring once again to decision point 4106, if it is determined no seasonality is present (4106—No), then the flowchart 4100 continues to module 4126 where a seasonal summary is found and ends at module 4128 where the seasonality map is stored.

The time series pattern analyzer calculates boost values. Input is 1) period type, such as the week of Jan. 4, 2021, to Jan. 10, 2021; 2) expected value, e.g., $50,000; 3) actual value, e.g., $2000; and 4) past time periods with actual and expected values, an example of which is shown in the Table 15:

| Past Time Period | Expected Value | Actual Value |
|---|---|---|
| Jan. 4, 2021 | $6000 | $2000 |

Input also includes 5) boosting time periods with expected values, an example of which is shown in Table 16:

| Boosting Time Period | Expected Value |
|---|---|
| Jan. 5, 2021 | $8500 |
| Jan. 6, 2021 | $4000 |
| Jan. 7, 2021 | $3000 |
| Jan. 8, 2021 | $6000 |
| Jan. 9, 2021 | $10000 |
| Jan. 10, 2021 | $12500 |

An example of output for the inputs is shown in Table 17:

| Boosting Time Period | Boosted Value |
|---|---|
| Jan. 5, 2021 | $9300 |
| Jan. 6, 2021 | $4300 |
| Jan. 7, 2021 | $3200 |
| Jan. 8, 2021 | $7000 |
| Jan. 9, 2021 | $12000 |
| Jan. 10, 2021 | $14200 |

Step 1: Find seasonality map using a time series pattern analyzer, such as a univariate time series pattern analyzer.

Step 2: Find the difference between excepted and actual value for past time periods. In this example the difference is $4000.

Step 3: Now we need to boost the expected values for future time periods to compensate for the day's shortfall ($4000). Here we need to distribute the $4000 value across future time periods based on their period importance which is calculated using its standard deviation.

Using a seasonality map derived from the time series pattern analyzer, find the standard deviations for boosting time periods. Then normalize the standard deviation values, an example of which is shown in Table 18:

| | | Normalized | Boosting contribution | Boosting value = Expected |
|---|---|---|---|---|
| Boosting | Standard | Standard | value = Normalized | value + Boosting |
| time period | deviation | deviation values | value * loss ($4000) | contribution value |
| Jan. 5, 2021 | 20 | 0.2 | 800 | $9300 |
| Jan. 6, 2021 | 7.5 | 0.075 | 300 | $4300 |
| Jan. 7, 2021 | 5 | 0.05 | 200 | $3200 |
| Jan. 8, 2021 | 25 | 0.25 | 1000 | $7000 |
| Jan. 9, 2021 | 50 | 0.5 | 2000 | $12000 |
| Jan. 10, 2021 | 42.5 | 0.425 | 1700 | $14200 |

Step 4: Find the boosting contribution value using the standard deviation. Boosting contribution value=Normalized value*loss. The calculated boosting contribution values are shown in the Table 18.

Step 5: Now boosting value for the future time steps is calculated by summing up its expected value with their expected value. (Refer the Table 18, which shows the boosting value for our running example.) The calculated boosting value should be within its min max range which is derived from the time series pattern analyzer.

Finally calculated booting value is returned to the user.

1. A system comprising:
a deep metrics discovery engine;
a target metrics/supporting metrics (TMSM) association modeling engine;
a strategy planning engine;
a descriptive analytics engine;
a predictive analytics engine;
a prescriptive analytics engine;
wherein, in operation:
the deep metrics discovery engine uses target metrics, data, and metadata and schema to generate important supporting metrics, supporting metrics meta information, and best grouping columns;
the TMSM association modeling engine uses the important supporting metrics, the supporting metrics meta information, and the best grouping columns to generate a forward model and a backward model;
the strategy planning engine obtains one or more of analysis period, agent-specified target metrics value, and agent-specified supporting metrics value to generate one or both of predicted target metrics value and predicted supporting metrics value;
the descriptive analytics engine uses the analysis period, historical data of target and supporting metrics, and anomaly scan direction to generate a target metrics anomaly score and anomaly reasoning;
the predictive analytics engine uses the best grouping columns and timeseries data to generate predicted values of target metrics for future periods with breakup;
the prescriptive analytics engine provides suggestions how to achieve expected targets.

2. The system of claim 1, comprising a server engine that provides the target metrics, data, and metadata to the deep metrics discovery engine, wherein the server engine obtains the target metrics from an agent device.

3. The system of claim 1, comprising a target metrics datastore that includes the target metrics, an important supporting metrics datastore that includes the important supporting metrics, a supporting metrics meta information datastore that includes the supporting metrics meta information, a best grouping columns datastore that includes the best grouping columns, a forward model datastore that includes the forward model, and a backward model datastore that includes the backward model.

4. The system of claim 1, wherein the deep metrics discovery engine includes a data sampler engine that randomly samples rows of a primary table and rows related to the randomly sampled rows from a secondary table that has a foreign key relationship with the primary table.

5. The system of claim 1, wherein the deep metrics discovery engine includes a preprocess engine that scans the metadata, marks time columns and formats the time columns to a uniform time zone, marks numerical columns based on the metadata and formats the numerical columns into a continuous format, marks categorical columns and formats the categorical columns based on the metadata.

6. The system of claim 1, wherein the deep metrics discovery engine includes an eligibility engine that removes columns that do not have sufficient information, checks whether enough rows are available for analysis, evaluates whether data is sufficiently distributed, and determines whether enough eligible columns are available for analysis.

7. The system of claim 1, wherein the deep metrics discovery engine includes a transform engine that uses numerical columns and binning to create categorical columns.

8. The system of claim 1, wherein the deep metrics discovery engine includes a supporting metrics synthesis engine that generates one or more metrics by varying an aggregate function, metrics by varying an aggregate column, metrics by varying a time column, and metrics by varying criteria; and that discovers metrics from an nth order related table.

9. The system of claim 1, wherein the deep metrics discovery engine includes an important supporting metrics (ISM) ranking engine that ranks metrics by importance, wherein importance is a degree of correlation between the target metrics and the supporting metrics over time.

10. The system of claim 1, wherein the deep metrics discovery engine includes a meta enrichment engine that performs one or more of display name enrichment, unit enrichment, upper and lower limit metrics value range determination, supporting metrics importance ranking, select query generation, correlation coefficient storage.

11. The system of claim 1, wherein the deep metrics discovery engine includes an important categorical claims discovery engine that determines the best grouping columns and determines values for the best grouping columns.

12. The system of claim 1, wherein the TMSM association modeling engine includes a forward modeling engine that generates the forward model, wherein the forward model is useful to predict the target metrics when fed values for the supporting metrics.

13. The system of claim 1, wherein the TMSM association modeling engine includes a backward modeling engine that generates the backward model, wherein the backward model is useful to predict the supporting metrics when fed a value for the target metrics.

14. The system of claim 1, wherein the strategy planning engine includes a timeseries engine that incorporates a univariate timeseries predictor algorithm.

15. The system of claim 1, wherein the strategy planning engine includes a TMSM sync engine that adjusts a value of the supporting metrics to make the forward model and the backward model in sync.

16. The system of claim 1, wherein the descriptive analytics engine includes a target metrics anomaly detection engine that incorporates a univariate timeseries anomaly detector algorithm.

17. The system of claim 1, wherein the descriptive analytics engine includes an anomaly reason finder engine that finds a reason for anomaly in target metrics by drilling into combinations of time period and fetching a root cause for the anomaly based on impact on the target metrics, wherein the reason has attributes that include supporting metrics name, start time, end time, effect on target, and severity score.

18. The system of claim 1, wherein the metadata and schema include one or more of a foreign key connection between tables, primary key column information, data type of each column of tables, display name of each column, units of numerical columns, and format and time zone information of date columns.

19. The system of claim 1, wherein the important supporting metrics discovered by the deep metrics discovery engine answers a question generated from the descriptive analytics engine, predictive analytics engine, and prescriptive analytics engine.

20. The system of claim 1, wherein the prescriptive analytics engine includes a univariate timeseries pattern analyzer to boost expected target metrics value of the expected targets based on influence of seasonal pattern.

21. A method comprising:
generating important supporting metrics, supporting metrics meta information, and best grouping columns using target metrics, data, and metadata and schema;
generating a forward model and a backward model using the important supporting metrics, the supporting metrics meta information, and the best grouping columns;
generating one or both of predicted target metrics value and predicted supporting metrics value using one or more of analysis period, agent-specified target metrics value, and agent-specified supporting metrics value;
generating a target metrics anomaly score and anomaly reasoning using the analysis period, historical data of target and supporting metrics, and anomaly scan direction;
generating predicted values of target metrics for future periods with breakup using the best grouping columns and timeseries data;
providing suggestions how to achieve expected targets.

22. The method of claim 21, comprising: providing the target metrics, data, and metadata to the deep metrics discovery engine, wherein the server engine obtains the target metrics from an agent device.

23. The method of claim 21, comprising: including the target metrics in a target metrics datastore, including the important supporting metrics in an important supporting metrics datastore, including the supporting metrics meta information in a supporting metrics meta information datastore, including the best grouping columns in a best grouping columns datastore, including the forward model in a forward model datastore, and including the backward model in a backward model datastore.

24. The method of claim 21, comprising: randomly sampling rows of a primary table and rows related to the randomly sampled rows from a secondary table that has a foreign key relationship with the primary table.

25. The method of claim 21, comprising: scanning the metadata, marking time columns and formatting the time columns to a uniform time zone, marking numerical columns based on the metadata and formatting the numerical columns into a continuous format, marking categorical columns and formatting the categorical columns based on the metadata.

26. The method of claim 21, comprising: removing columns that do not have sufficient information, checking whether enough rows are available for analysis, evaluating whether data is sufficiently distributed, and determining whether enough eligible columns are available for analysis.

27. The method of claim 21, comprising: using numerical columns and binning to create categorical columns.

28. The method of claim 21, comprising: generating one or more metrics by varying an aggregate function, metrics by varying an aggregate column, metrics by varying a time column, and metrics by varying criteria; and that discovers metrics from an nth order related table.

29. The method of claim 21, comprising: ranking metrics by importance, wherein importance is a degree of correlation between the target metrics and the supporting metrics over time.

30. The method of claim 21, comprising: performing one or more of display name enrichment, unit enrichment, upper and lower limit metrics value range determination, supporting metrics importance ranking, select query generation, correlation coefficient storage.

31. The method of claim 21, comprising: determining the best grouping columns and determines values for the best grouping columns.

32. The method of claim 21, comprising: generating the forward model, wherein the forward model is useful to predict the target metrics when fed values for the supporting metrics.

33. The method of claim 21, comprising: generating the backward model, wherein the backward model is useful to predict the supporting metrics when fed a value for the target metrics.

34. The method of claim 21, comprising: incorporating a univariate timeseries predictor algorithm.

35. The method of claim 21, comprising: adjusting a value of the supporting metrics to make the forward model and the backward model in sync.

36. The method of claim 21, comprising: incorporating a univariate timeseries anomaly detector algorithm.

37. The method of claim 21, comprising: finding a reason for anomaly in target metrics by drilling into combinations of time period and fetching a root cause for the anomaly based on impact on the target metrics, wherein the reason has attributes that include supporting metrics name, start time, end time, effect on target, and severity score.

38. The method of claim 21, wherein the metadata and schema include one or more of a foreign key connection between tables, primary key column information, data type of each column of tables, display name of each column, units of numerical columns, and format and time zone information of date columns.

39. The method of claim 21, wherein the important supporting metrics answers a question.

40. The method of claim 21, comprising boosting expected target metrics value of the expected targets based on influence of seasonal pattern.

41. A system comprising:
a means for generating important supporting metrics, supporting metrics meta information, and best grouping columns using target metrics, data, and metadata and schema to;
a means for generating a forward model and a backward model using the important supporting metrics, the supporting metrics meta information, and the best grouping columns;
a means for generating one or both of predicted target metrics value and predicted supporting metrics value using one or more of analysis period, agent-specified target metrics value, and agent-specified supporting metrics value;
a means for generating a target metrics anomaly score and anomaly reasoning using the analysis period, historical data of target and supporting metrics, and anomaly scan direction;
a means for generating predicted values of target metrics for future periods with breakup using the best grouping columns and timeseries data;
a means for providing suggestions how to achieve expected targets.
